(19) United States
(12) Patent Application Publication
(10) Pub. No.: US 2002/0006374 A1
(43) Pub. Date: Jan. 17, 2002

(54) Chromium-based catalysts and processes for converting hydrocarbons to synthesis gas

(76) Inventors: Kostantinos Kourtakis, Swedesboro, NJ (US); Anne M. Gaffney, West Chester, PA (US); Lin Wang, Wilmington, DE (US)

Correspondence Address: Joanna K. Payne, CONOCO INC., 1000 South Pine 2635 RW, P O Box 1267, Ponca City, OK, 74602-1267, US

(21) Appl. No.: 09/785,384

(22) Filed: Feb. 16, 2001

Related U.S. Application Data
(63) Continuation-in-part of application No. 09/703,701, filed on Nov. 1, 2000.
(60) Provisional application No. 60/183,423, filed on Feb. 18, 2000.
(60) Provisional application No. 60/163,843, filed on Nov. 5, 1999.

(51) Int. Cl. C01B 31/18; C01B 3/26; B01J 23/26

(52) U.S. Cl. 423/418.2; 502/304; 502/303; 502/302; 502/306; 502/307; 502/315; 502/317; 502/318; 502/319; 423/651

(57) ABSTRACT

Processes for the catalytic conversion of hydrocarbons to carbon monoxide and hydrogen employing new chromium-based catalysts are disclosed. One highly active and selective catalyst system, providing greater than 95% CH₄ conversion, and 97-98 % selectivity to CO and H₂, is a chromium-containing catalyst consisting of a CoCr₂O₄ cubic spinel precursor dispersed in a chromium oxide matrix. Some other preferred catalysts compositions comprise nickel-chromium containing and rare earth-chromium containing compounds.

### CROSS-REFERENCE TO RELATED APPLICATIONS

This application claims the benefit under 35 U.S.C. § 119(e) of U.S. Provisional Application No. 60/183,423 filed Feb. 18, 2000 and is a continuation-in-part of co-pending U.S. application Ser. No. 09/703,701 filed Nov. 1, 2000. This application is also related to U.S. Provisional Application No. 60/183,575 filed Feb. 18, 2000, which corresponds to co-pending U.S. Non-Provisional Patent Application No. ______ filed______.

### BACKGROUND OF THE INVENTION

1. Field of the Invention

The present invention relates to catalysts and processes for the catalytic conversion of hydrocarbons (e.g., natural gas) using chromium-based catalysts to produce carbon monoxide and hydrogen. More particularly, the invention relates to such catalysts and their manner of making, and to processes employing the catalysts.

2. Description of Related Art

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or “syngas”). In a second step, the syngas is converted to hydrocarbons, for example, using the Fischer-Tropsch process to provide fuels that boil in the middle distillate range, such as kerosene and diesel fuel, and hydrocarbon waxes.

Current industrial use of methane as a chemical feedstock proceeds by the initial conversion of methane to carbon monoxide and hydrogen by either steam reforming, which is the most widespread process, or by dry reforming. Steam reforming currently is the major process used commercially for the conversion of methane to synthesis gas, proceeding according to Equation 1.

CH₄+H₂O⇄CO+3H₂ (1)

Although steam reforming has been practiced for over five decades, efforts to improve the energy efficiency and reduce the capital investment required for this technology continue.

The catalytic partial oxidation of hydrocarbons, e.g., natural gas or methane to syngas is also a process known in the art. While currently limited as an industrial process, partial oxidation has recently attracted much attention due to significant inherent advantages, such as the fact that significant heat is released during the process, in contrast to steam reforming processes.

In catalytic partial oxidation, natural gas is mixed with air, oxygen-enriched air, or oxygen, and introduced to a catalyst at elevated temperature and pressure. The partial oxidation of methane yields a syngas mixture with a H₂:CO ratio of 2: 1, as shown in Equation 2.

CH₄+1/2O₂⇄CO+2H₂ (2)

This ratio is more useful than the H₂:CO ratio from steam reforming for the downstream conversion of the syngas to chemicals such as methanol and to fuels. The partial oxidation is also exothermic, while the steam reforming reaction is strongly endothermic. Furthermore, oxidation reactions are typically much faster than reforming reactions. This allows the use of much smaller reactors for catalytic partial oxidation processes. The syngas in turn may be converted to hydrocarbon products, for example, fuels boiling in the middle distillate range, such as kerosene and diesel fuel, and hydrocarbon waxes by processes such as the Fischer-Tropsch Synthesis.

The selectivities of catalytic partial oxidation to the desired products, carbon monoxide and hydrogen, are controlled by several factors, but one of the most important of these factors is the choice of catalyst composition. Difficulties have arisen in the prior art in making such a choice economical. Typically, catalyst compositions have included precious metals and/or rare earths. The large volumes of expensive catalysts needed by prior art catalytic partial oxidation processes have placed these processes generally outside the limits of economic justification.

For successful operation at commercial scale, the catalytic partial oxidation process must be able to achieve a high conversion of the methane feedstock at high gas hourly space velocities, and the selectivity of the process to the desired products of carbon monoxide and hydrogen must be high. Such high conversion and selectivity must be achieved without detrimental effects to the catalyst, such as the formation of carbon deposits (“coke”) on the catalyst, which severely reduces catalyst performance. Accordingly, substantial effort has been devoted in the art to the development of catalysts allowing commercial performance without coke formation.

A number of process regimes have been described in the art for the production of syngas via catalyzed partial oxidation reactions. The noble metals, which typically serve as the best catalysts for the partial oxidation of methane, are scarce and expensive. The widely used, less expensive, nickel-based catalysts have the disadvantage of promoting coke formation on the catalyst during the reaction, which results in loss of catalytic activity.

U.S. Pat. No. 5,149,516 discloses a process for the partial oxidation of methane comprising contacting methane and a source of oxygen with a perovskite of the formula ABO₃, where B can be a variety of metals including Cr. In the example shown, the perovskite that was used is LaCoO₃. M. Stojanovic et al., (J. Catal. (1997) 166 (2), 324-332) disclose the use of chromium-containing ternary perovskite oxides, LaCr₁₋ₓNiₓO₃ (x=0 to 1.0) as catalysts for the partial oxidation of methane to syngas. The catalytic activity was found to increase monotonically with the value of x, i.e., LaCrO₃ was found to be the least active catalyst. U.S. Pat. No. 5,447,705 also discloses a process for the partial oxidation of methane to syngas by contacting the starting materials with a catalyst having a perovskite crystalline structure and having the composition LnₓA_{1-y}B_{y}O₃, in which x is a number such that 0<x<10, y is a number such that 0<y<1, Ln is at least one of a rare earth, strontium or bismuth, A is a metal of groups IVb, Vb, VIb, Vllb or VIII, A is a metal of groups IVb, Vb, VIb, VIIb or VIII and A and B are two different metals. Various combinations of La, Ni and Fe were exemplified.

U.S. Pat. No. 5,149,464 discloses a method for selectively converting methane to syngas at 650° C. to 950° C. by contacting the methane/oxygen mixture with a solid catalyst, which is either: (a) a catalyst of the formula MₓM′_{y}O_{z} where: M is at least one element selected from Mg, B, Al, Ln, Ga, Si, Ti, Zr and Hf, Ln is at least one member of lanthanum and the lanthanide series of elements, M′ is a d-block transition metal, and each of the ratios x/z and y/z and (x+y)/z is independently from 0.1 to 8; or (b) an oxide of a d-block transition metal; or (c) a d-block transition metal on a refractory support ; or (d) a catalyst formed by heating a) or b) under the conditions of the reaction or under non-oxidizing conditions. The d-block transition metals are selected from those having atomic number 21 to 29, 40 to 47 and 72 to 79, the metals Sc, Ti, Va, Cr, Mn, Fe, Co, Ni, Cu, Zr, Nb, Mo, Tc, Ru, Rh, Pa, Ag, Hf, Ta, W, Re, Os, Ir, Pt and Au. Preferably M′ is selected from Fe, Os, Co, Rh, Ir, Pd, Pt and particularly Ni and Ru.

U.S. Pat. No. 5,431,855 describes a catalyst which catalyzes the combined partial oxidation-dry reforming reaction of a reactant gas mixture comprising CO₂, O₂ and CH₄ to for a product gas mixture comprising CO and H₂. Related patent U.S. Pat. No. 5,500,149 describes similar catalysts and methods for production of product gas mixtures comprising H₂ and CO.

U.S. Pat. No. 2,942,958 discloses an improved method for converting methane to carbon monoxide and hydrogen employing a reforming catalyst for the steam-methane reaction. Although it is stated that any reforming catalyst is suitable for the process, the preferred catalysts are nickel, chromium and cobalt, or their oxides.

U.S. Pat. No. 4,843,181 discloses a process for preparing Cr₂O₃ that includes pyrolysis of ammonium dichromate. The chromium oxide is employed in a process for manufacturing 1,1,1-trifluorodichloroethane and 1,1,1,2-tetrafluorochloroethane. U.S. Pat. No. 5,036,036 discloses an improved Cr₂O₃ catalyst composition, prepared by pyrolysis of ammonium dichromate, which is useful in hydrofluorination reactions.

An example of the previous attempts at synthesis gas production by catalytic partial oxidation to overcome some of the disadvantages and costs of steam reforming are described in EP303438 entitled “Production of Methanol from Hydrocarbonaceous Feedstock”. The asserted advantages of EP303438 are relatively independent of catalyst composition, i.e., “partial oxidation reactions will be mass transfer controlled. Consequently, the reaction rate is relatively independent of catalyst activity, but dependent on surface area-to-volume ratio of the catalyst”. A monolith catalyst is used with or without metal addition to the surface of the monolith at space velocities of 20,000-500,000 hr⁻1. The suggested metal coatings of the monolith are selected from the exemplary list of palladium, platinum, rhodium, iridium, osmium, ruthenium, nickel, chromium, cobalt, cerium, lanthanum, and mixtures thereof in addition to metals of the groups IA, IIA, III, IV, VB, VIB, or VIIB. An exemplary catalyst comprises alumina on cordierite, with a coating comprising platinum and palladium. Steam is required in the feed mixture to suppress coke formation on the catalyst. Products from the partial oxidation of methane employing these catalysts results in the production of significant quantities of carbon dioxide, steam, and C₂+hydrocarbons.

None of the prior art processes or catalysts describes a completely satisfactory catalyst or process capable of high conversion and high selectivity for CO and H₂ products and which are capable of operation with very low coke formation. Accordingly, there remains a need for a process and catalyst for converting hydrocarbons, particularly methane, that have low coke formation, high conversions of methane and high selectivities to CO and H₂, and which are economically feasible at commercial-scale conditions.

### SUMMARY OF THE INVENTION

Many of the shortcomings of conventional syngas manufacturing methods are overcome by the processes and catalysts of the present invention. The preferred chromium-based catalysts provide higher levels of activity (i.e., conversion of CH₄) and high selectivity to CO and H₂ reaction products than is typically available with conventional catalytic systems designed for commercial-scale use. Another advantage of the catalytic compositions and syngas production processes of the invention is that no appreciable coking occurs with use of many of the chromium-containing catalyst compositions. Still another advantage of the new catalysts and processes is that they are more economically feasible for use in commercial-scale conditions than conventional catalysts now used for producing syngas. Some catalyst compositions containing higher-melting-point pure ceramic oxides instead of metals, demonstrate improved catalyst life when used for production of syngas.

In accordance with one aspect of the invention, a process for the catalytic conversion of a hydrocarbon feedstock to syngas is provided. Conversion of the hydrocarbon is achieved by contacting a feed stream comprising the hydrocarbon feedstock and an oxygen-containing gas with a chromium-based catalyst in a reaction zone maintained at conversion-promoting conditions effective to produce an effluent stream comprising carbon monoxide and hydrogen.

In accordance with another aspect of the invention is provided catalyst compositions comprising a chromium-containing compound optionally combined with at least one metal selected from the group consisting of Group 1, Group 2, Group 11 and Group 12 of the periodic table of the elements; a metal with an atomic number of 57 through 71; Co, Ru, Rh, Pd, Ir, Pt, Al, Ti, Y and Zr, and optionally Si. The preferred compositions do not have a perovskite structure. Yet another aspect of the present invention includes methods of making the new chromium-based catalytic compositions.

As discussed in more detail below, many of the new chromium-based catalysts exhibit high methane oxidation activities and selectivities to syngas (CO and H₂) in a millisecond contact time reactor. The low light-off temperatures of these materials (i.e., less than 650° C.) and superior performance are indicative of the more preferred catalytic compositions. Pure chromium oxide catalysts, and chromium catalysts containing rare earth oxides show little or no carbon or coke build-up after reaction with CH₄/O₂. Trends in light-off temperature appear to correlate with the basicity or ionicity of the rare earth components, which may, in turn, relate to trends in C-H activation. Chromium oxide-based catalysts containing cobalt show carbon deposition on the reduced cobalt metal particles which are formed in situ.

In accordance with certain embodiments of the present invention, a chromium-based composition for catalyzing the conversion of a C₁-C₅ hydrocarbon to form a product gas mixture containing CO and H₂ is provided. The composition comprises about 0.1-100 mole % of chromium or chromium-containing compound per total moles of metal or metal ion in the composition. The composition also includes at least one other elemental metal or metal-containing compound, the metal of which is Li, Na, K, Rb, Cs, Mg, Ca, Sr, Ba, Cu, Ag, Au, Zn, Cd, La, Ce, Pr, Nd, Sm, Eu, Gd, Tb, Dy, Ho, Er, Tm, Yb, Lu, Co, Ni, Ru or Rh. In some embodiments the composition may also contain an oxidatively and thermally stable porous support. Preferably the chromium-based composition does not have a perovskite structure. In certain embodiments which include a porous material, or support, the porous material may include at least one oxide or oxyhydroxide of a metal such as magnesium, silicon, titanium, tantalum, zirconium or aluminum.

In some embodiments of the catalyst compositions the chromium or chromium-containing compound comprises about 10-100 mole % of the total moles of metal or metal ion in said composition. In some embodiments the catalyst composition initially comprises a catalyst precursor comprising a mixed metal oxide, and after reaction in a syngas reactor, the catalyst finally comprises reduced metal and metal oxide. In some of these embodiments, the catalyst precursor comprises CoCr₂O₄, the reduced metal is zero valent cobalt metal, and the metal oxide is Cr₂O₃. Some of these compositions finally comprise, after exposure to reaction conditions for a period of time, metal oxide and substantially no deposited carbon.

In some embodiments, the composition comprises a matrix structure which is a xerogel or an aerogel. In some embodiments the matrix structure comprises at least one oxide or oxyhydroxide of a metal such as magnesium, silicon, titanium, tantalum, zirconium or aluminum. Certain chromium-based compositions of the invention have a matrix structure comprising at least 30 wt %, preferably about 30-99.9 mole %, and more preferably about 50-97.5 mole % of the total moles (of metal) of the composition. In some embodiments the matrix structure comprises titanium oxide/oxyhydroxide, or magnesium oxide/oxyhydroxide and silicon oxide/oxyhydroxide. In some embodiments the chromium-based composition also contains cobalt or a cobalt-containing compound. In some embodiments, the composition also includes lanthanum or a lanthanum-containing compound. Certain catalytic chromium-based compositions contain magnesium or a magnesium-containing compound and silicon oxide/oxyhydroxide. In certain embodiments, the chromium-based composition contains cerium or samarium, or compounds containing those metals. There are some embodiments that include gold and aluminum oxide/oxyhydroxide, in addition to chromium or a chromium-containing compound. In other embodiments, the chromium-based catalytic composition comprises gold or a gold-containing compound and magnesium oxide/oxyhydroxide. Still other embodiments contain lanthanum and lithium, or compounds containing those elements, and α-Al₂O₃, in addition to chromium or a chromium-containing compound.

Some embodiments of the chromium-based catalytic compositions comprise a catalyst support, which may be oxidatively and thermally stable. The catalyst support may also be in the form of a porous three-dimensional monolith or it could be a reticulated ceramic or ceramic foam.

In accordance with another aspect of the invention, a process in provided for preparing a chromium-based composition for catalyzing the partial oxidation of a C₁-C₅ hydrocarbon to form a product gas mixture comprising CO and H₂. This process comprises combining about 0.1-100 mole % elemental chromium or chromium-containing compound per total moles of metal in the composition, together with, optionally, at least one other metal or metal oxide the metal component of which is Li, Na, K, Rb, Cs, Mg, Ca, Sr, Ba, Cu, Ag, Au, Zn, Cd, La, Ce, Pr, Nd, Sm, Eu, Gd, Tb, Dy, Ho, Er, Tm, Yb, Lu, Co, Ni, Ru or Rh. Optionally the composition also contains at least one matrix-forming material such as an alkoxide of magnesium, silicon, titanium, tantalum, zirconium or aluminum. The process also includes forming the combination into a porous solid. The matrix-forming material may be at least 30 wt % of the total weight of said composition with said chromium compound and said at least one other metal compound. In some embodiments the matrix-forming material comprises titanium or titanium oxide, or a combination of oxides or alkoxides of magnesium and silicon.

In some embodiments, the process also includes preparing an intermediate composition containing the chromium or chromium-containing compound and at least one other metal or metal-containing compound. In this embodiment, the process includes applying the intermediate composition to a porous matrix material comprising at least 30 wt % of the total weight of the composition. The porous matrix material may comprise a porous monolith support and the intermediate composition may be in the form of a liquid which is applied to the porous matrix material by impregnation. In some embodiments, the intermediate composition is dried, or calcined. Certain embodiments of the process provide for calcining the composition in situ under reaction conditions. In some embodiments the composition is formed by freeze-drying, spray drying or spray roasting the intermediate composition. In some embodiments, a powder is formed, which may be compressed into a pellet. Other embodiments of the process for making a chromium-based catalyst composition include forming an extrudate, or a gel such as a xerogel or aerogel.

In some embodiments, the process of making a chromium-based catalytic composition employs a matrix-forming material comprising at least one metal alkoxide. The metal alkoxide may contain 1 to 20 carbon atoms, and in some embodiments contains 1 to 5 carbon atoms. Some embodiments combine with the chromium or chromium-containing compound at least one metal alkoxide that is a C₁-C₄ alkoxide such as tantalum n-butoxide, titanium isopropoxide or zirconium isopropoxide. In certain embodiments of the process of making the chromium-based catalyst composition, the process includes dissolving at least one of the metal alkoxides in a non-aqueous medium to form a metal alkoxide solution. In some of these embodiments, the metal alkoxide solution is mixed with a protic solvent, such as water, whereby the alkoxide(s) react(s) with the protic solvent to form a gel. Some embodiments include first dissolving the chromium or chromium-containing compound in the protic solvent to form a protic catalytic metal solution. In some alternative embodiments, the process may include dissolving or suspending the matrix material in the non-aqueous liquid medium to form a non-aqueous matrix solution or colloidal suspension. In some embodiments, the process may include dissolving at least one other elemental metal or metal-containing compound and one or more matrix-forming component in a non-aqueous medium.

Certain embodiments of the process for making a chromium-based catalytic composition provide for combining a protic solvent and an alkoxide in a molar ratio of about 5:1 to 53.1 or about 26.5:1. The process may include the gradual addition and mixing of sufficient protic solution to induce hydrolysis and condensation of the metal alkoxide(s). In certain embodiments the mixing comprises combining water and the alkoxide in a molar ratio of about 0.1:1 to 10:1 water:alkoxide. Some embodiments include combining water and zirconium alkoxide or titanium alkoxide in a molar ratio of about 4:1.

In accordance with yet another aspect of the present invention, processes are provided for converting a C₁-C₅ hydrocarbon to form a product gas mixture containing CO and H₂. In certain embodiments the process comprises mixing a C₁-C₅ hydrocarbon-containing feedstock and an oxygen-containing feedstock to provide a reactant gas mixture. The process includes contacting said reactant gas mixture with a catalytically effective amount of one of the above-described chromium-based catalyst compositions. During the catalyst/reactant gas contacting period, the composition and the reactant gas mixture are maintained at a temperature of about 600-1,100° C. or about 700-1,000° C. The catalyst composition/reactant gas system is also maintained at a pressure of about 100-12,500 kPa, preferably about 130-10,000 kPa, and the reactant gas mixture is passed over the catalyst composition at a continuous flow rate of about 20,000 to about 100,000,000 NL/kg/h, preferably about 50,000 - 50,000,000 NL/kg/h. In the most preferred embodiments the reactant gas/catalyst composition contact time is 10 milliseconds or less. Some embodiments of the syngas manufacturing process include mixing a methane-containing gas feedstock and an oxygen-containing gas feedstock to provide a reactant gas mixture having a carbon:oxygen ratio of about 1.25:1 to about 3.3:1, or about 1.3:1 to about 2.2:1, or about 1.5:1 to about 2.2:1, preferably about 2:1.

In some embodiments of the hydrocarbon conversion processes, the oxygen-containing gas further comprises steam, CO₂, or a combination thereof. In some embodiments the process comprises mixing a hydrocarbon feedstock and a gas comprising steam and/or CO₂ to provide a reactant gas mixture. In some embodiments the C₁-C₅ hydrocarbon comprises at least about 50% methane by volume of the reactant gas mixture, preferably at least about 75%, and more preferably at least about 80% methane by volume of the reactant gas mixture. Certain embodiments of the processes of making syngas provide for preheating the hydrocarbon feedstock and/or the oxygen-containing feedstock before contacting the catalyst composition. In some embodiments the reactant gases are preheated to temperatures up to about 700° C. In some embodiments the catalyst composition is in a fixed bed reaction zone.

One embodiment of the process of converting a hydrocarbon to methane and hydrogen employs a particularly highly active and selective catalyst system. This process includes mixing a C₁-C₅ hydrocarbon-containing feedstock and an oxygen-containing feedstock to provide a reactant gas mixture. The reactant gas mixture is contacted with a catalytically effective amount of a CoCr₂O₄ cubic spinel precursor dispersed in a chromium oxide matrix. During this contacting, the catalyst composition and the reactant gas mixture are maintained at a temperature of about 600-1,100° C. and at a pressure of about 100-12,500 kPa. The reactant gas mixture is passed over the catalyst composition at a continuous flow rate of about 20,000 to about 100,000,000 NL/kg/h. At least a portion of the catalyst precursor is reduced to cobalt metal (in a chromium oxide matrix) by the heated gases of the reactant stream. Some of the more preferred embodiments of the syngas production process achieve greater than 95% CH₄ conversion of the hydrocarbon in the reactant gas mixture, and at least about 97-98% selectivity to CO and H₂ products.

Certain embodiments provide a process for converting a C₁-C₅ hydrocarbon that contains at least about 80 vol% methane to form a product gas mixture comprising CO and H₂. This process may include mixing a methane-containing gaseous feedstock and an oxygen-containing gaseous feedstock to provide a reactant gas mixture having a carbon:oxygen ratio of about 1.25:1 to about 3.3:1. The gaseous feedstocks are preheated and combined, and the reactant gas mixture is then contacted with a catalytically effective amount of a chromium-based composition containing about 10-100 mole % (as the metal) chromium or chromium-containing compound per total moles of metal or metal ion in the catalyst composition. The catalyst composition also contains 0-90% cobalt or cobalt-containing compound, and optionally, an oxidatively and thermally stable porous support supporting the chromium or chromium-containing compound and the cobalt or cobalt-containing compound. In preferred embodiments the catalyst composition comprises a structure other than a perovskite structure. During the gas/catalyst contacting period, the composition and reactant gas mixture are maintained at a temperature of about 600-1,100° C. and at a pressure of about 100-12,500 kPa. The reactant gas mixture is passed over the catalytic composition at a continuous flow rate of about 20,000 to 100,000,000 NL/kg/h, preferably ensuring a reactant gas/catalyst composition contact time of no more than about 10 milliseconds.

In some embodiments of the syngas manufacturing methods the catalytic composition is nominally 0.8 mole % in elemental chromium or chromium ion and 0.2 mole % in elemental cobalt or cobalt ion. In other embodiments the composition is nominally 0.2 mole % in elemental chromium or chromium ion and 0.8 mole % in elemental cobalt or cobalt ion. In still other embodiments the composition is nominally 0.5 mole % in elemental chromium or chromium ion and 0.5 mole % in elemental cobalt or cobalt ion.

Certain embodiments of the processes for converting a hydrocarbon to yield CO and H₂ employ a catalytic composition that is nominally 2-10 mole % chromium or chromium ion, 1 mole % in lithium or lithium ion and 27 mole % lanthanum or lanthanum ion and also includes an alpha-alumina support. Such processes preferably provide at least 90% conversion of CH₄ and at least 90% selectivities for CO and H₂ products. Other embodiments, features and advantages of the present invention will become apparent with reference to the following figures and description.

### BRIEF DESCRIPTION OF THE DRAWINGS

FIG. 1 is a bar graph comparing the catalyst performance of three pure chromium oxide systems. The black bars indicate the % CH₄ conversion and the cross-hatched bars indicate the % CO selectivity.

FIG. 2A is a transmission electron microscopy photomicrograph showing the crystal structure of a representative freeze-dried chromium oxide catalyst as prepared.

FIG. 2B is similar to FIG. 2A but was taken after the catalyst was employed 6 hours on stream.

FIG. 3 is a graph showing trends in light-off temperature and basicity/ionicity of representative “support” matrix compositions.

FIG. 4 is a graph showing the results of thermal gravimetric analysis (TGA) studies of a representative rare earth oxide based chromium catalyst.

FIG. 5 is a graph showing the reaction chemistry for several representative ternary freeze dried chromium oxides containing chromium and cobalt.

FIG. 6A is X-ray diffraction data for the catalyst precursor Co_{0.2}Cr_{0.8}Ox following reaction in situ (i.e., on stream). FIG. 6B is like FIG. 6A, except the catalyst specimen was taken before reactor evaluation.

FIG. 7 A shows the X-ray diffraction data for Co_{0.2}Cr_{0.8}Ox after reactor evaluation. FIG. 7 B shows the X-ray diffraction data for Co_{0.5}Cr_{0.8}Ox after reactor evaluation, and FIG. 7 C shows the X-ray diffraction data for Co_{0.8}Cr_{0.2}Ox after reactor evaluation.

### DETAILED DESCRIPTION OF PREFERRED EMBODIMENTS

Catalyst Preparation

The chromium-containing catalysts useful for catalyzing the partial oxidation of methane to CO and H₂ are prepared by employing a variety of known art techniques such as impregnation, xerogel or aerogel formation, freeze-drying, spray drying, and spray roasting. In addition to catalyst powders, extrudates and pellets, monoliths can be used as supports provided that they have sufficient porosity for reactor use. The supports used with some of the catalyst compositions may be in the form of monolithic supports or other configurations having longitudinal channels or passageways permitting high space velocities with a minimal pressure drop. Such configurations are known in the art and described in, for example, Structured Catalysts and Reactors, A. Cybulski and J. A. Moulijn (Eds.), Marcel Dekker, Inc., 1998, p. 599-615 (Ch. 21, X. Xu and J. A. Moulijn, “Transformation of a Structured Carrier into Structured Catalyst”). Additionally, some of the preferred three-dimensional forms of these new catalysts include chromium oxide reticulated ceramics or ceramic foams, and directly deposited materials on three-dimensional monoliths, which are needed for millisecond contact time reactors and for commercial use. The impregnation techniques preferably comprise contacting the support with a solution of a compound of the catalytically active material, or a solution of compounds of the catalytically active materials or their precursors. The contacting is followed by drying and calcining, or transforming or thermally treating the supported materials under reaction conditions; in some cases this thermal treatment can be accomplished in situ under reaction conditions.

A key component of the most preferred catalysts is chromium, and optionally at least one other metal selected from the group consisting of Group 1 (i.e., Li, Na, K, Rb and Cs); Group 2 (i.e., Mg, Ca, Sr and Ba); Group 11 (i.e., Cu, Ag and Au); Group 12 (i.e., Zn and Cd); metals with atomic numbers of 57 through 71 (i.e., La, Ce, Pr, Nd, Sm, Eu, Gd, Tb, Dy, Ho, Er, Tm, Yb and Lu), Co, Ni, Ru and Rh. The catalyst, or catalytic composition, must contain a catalytically effective amount of the metal component(s). The amount of catalytic metal present in the composition may vary widely. Preferably the catalyst comprises from about 0.1 mole % to about 100 mole % (as the metal) of chromium per total moles of catalytic metal and matrix metal, and more preferably from about 10 mole % to about 100 mole %. A matrix is a skeletal framework of oxides and oxyhydroxides. One or more of the catalytic components may also serve as a matrix material in which another catalytic metal or metal-containing compound is dispersed. For example, a catalyst composition may include a CoCr₂O₄ cubic spinel catalyst precursor dispersed in a chromium oxide matrix. This catalyst precursor is then reduced to cobalt metal in a chromium oxide matrix by the hot gases of the reactant stream. A suitable matrix can also be obtained from the hydrolysis and condensation of alkoxides and/or other reagents. Alternatively, or additionally, an oxidatively and thermally stable material may serve as a matrix or a support for the catalyst composition. For example, a composition containing (in wt %) 10% Cr, 1% Li, 27% La and α-Al₂O₃ may be used.

Xerogels and Aerogels from Metal Alkoxides

For the purposes of this disclosure, the term “gel” refers to a coherent, rigid three-dimensional polymeric network. As described in more detail below, the present gels are formed in a liquid medium, usually water, alcohol, or a mixture thereof. The term “alcogel” refers to gels in which the pores are filled with predominantly alcohol. Gels whose pores are filled primarily with water may be referred to as aquagels or hydrogels. A “xerogel” is a gel from which the liquid medium has been removed and replaced by a gas. In general, the structure is compressed and the porosity reduced significantly by the surface tension forces that occur as the liquid is removed. As soon as liquid begins to evaporate from a gel at temperatures below the critical temperature, surface tension creates concave menisci in the gel's pores. As evaporation continues, the menisci retreat into the gel body, compressive forces build up around its perimeter, and the perimeter contracts, drawing the gel body inward. Eventually surface tension causes significant collapse of the gel body and a reduction of volume, often as much as two-thirds or more of the original volume. This shrinkage causes a significant reduction in the porosity, often as much as 90 to 95 percent depending on the system and pore sizes.

In contrast to a xerogel, an “aerogel” is a gel from which the liquid has been removed in such a way as to prevent significant collapse or change in the structure as liquid is removed. This is typically accomplished by heating the liquid-filled gel in an autoclave while maintaining the prevailing pressure above the vapor pressure of the liquid until the critical temperature of the liquid has been exceeded, and then gradually releasing the vapor, usually by gradually reducing the pressure either incrementally or continuously, while maintaining the temperature above the critical temperature. The critical temperature is the temperature above which it is impossible to liquefy a gas, regardless of how much pressure is applied. At temperatures above the critical temperature, the distinction between liquid and gas phases disappears and so do the physical manifestations of the gas/liquid interface. In the absence of an interface between liquid and gas phases, there is no surface tension and hence no surface tension forces to collapse the gel. Such a process may be termed “supercritical drying.” Aerogels produced by supercritical drying typically have high porosities, on the order of from 50 to 99 percent by volume.

The new xerogels or aerogels preferably comprise a matrix material that is essentially derived from a solution of one or more matrix components and incorporate the active catalyst component(s). The active catalyst components are preferably derived from one or more dissolved component. The matrix is a skeletal framework of oxides and oxyhydroxides derived from the hydrolysis and condensation of alkoxides and/or other reagents. This framework preferably comprises 30% or more, by weight, of the total catalyst composition. The matrix material comprises magnesium, silicon, titanium, zirconium or aluminum, oxide/hydroxide xerogels or aerogels, or mixtures thereof, totaling from 30 to 99.9 mole %, preferably 50-97.5 mole % of the catalyst composition. Especially preferred are combinations where the matrix metal is Ti and combinations where the matrix metal is a combination of Mg and Si.

In preparing a chromium-based catalyst, one or more metal alkoxides (e.g., titanium n-butoxide) may be used as starting material for preparing the gels. Suitable metal alkoxides are any alkoxide that contains from 1 to 20 carbon atoms, preferably 1 to 5 carbon atoms, in the alkoxide group. It is also preferred that the alkoxide is soluble in the liquid reaction medium. C₁-C₄ alkoxides such as tantalum n-butoxide, titanium isopropoxide and zirconium isopropoxide are especially preferred. Commercially available alkoxides can be used, if desired. In addition, suitable alkoxides can be prepared by other routes. Some examples include direct reaction of zero valent metals with alcohols in the presence of a catalyst. Many alkoxides can be formed by reaction of metal halides with alcohols. Alkoxy derivatives can be synthesized by the reaction of the alkoxide with alcohol in a ligand interchange reaction. Direct reactions of metal dialkylamides with alcohol also form alkoxide derivatives. Additional examples are disclosed in “Metal Alkoxides” by D. C. Bradley et al., Academic Press, (1978).

The first step in the synthesis of the gels containing alcohol, or alcogels, consists of first preparing non-aqueous solutions of the alkoxides and other reagents and separate solutions containing protic solvents such as water. When the alkoxide solutions are mixed with the solutions containing the protic solvents, the alkoxides will react and polymerize to form a gel.

The medium utilized in the process generally should be a solvent for the alkoxide or alkoxides which are utilized and the additional metal reagents and promoters which are added in the single step synthesis. Solubility of all components in their respective media (aqueous and non-aqueous) is preferred to produce highly dispersed materials. By employing soluble reagents in this manner, mixing and dispersion of the active metals and promoter reagents can be near atomic, in fact mirroring their dispersion in their respective solutions. The precursor gel thus produced by this process will contain highly dispersed active metals and promoters. High dispersion results in catalyst metal particles in the nanometer size range.

It is preferred that the catalytic metal component of the gel is dissolved in a separate protic solvent (e.g., water) and this solution of catalytic metal compound(s) is then mixed with the non-aqueous solution of the matrix component(s). Alternatively, the catalytic metal component is dissolved in the same non-aqueous solution as the matrix component(s), and an aqueous supplement is used.

The concentration or amount of solvent used is linked to the alkoxide content. A molar ratio of 26.5:1 ethanol:total alkoxide can be used, although the molar ratio of ethanol:total alkoxide can be from about 5:1 to 53:1, or even greater. If a large excess of alcohol is used, gelation will not generally occur immediately; some solvent evaporation will be needed. At lower solvent concentrations, it is thought by the inventors that a heavier gel will be formed having less pore volume and surface area.

The process continues with adding to the alcohol soluble alkoxide and other reagents, water and any aqueous solutions, in a dropwise fashion, to induce hydrolysis and condensation reaction. Depending on the alkoxide system, a discernible gel point can be reached in minutes or hours. The molar ratio of the total water added to total Mg, Si, Ti, Zr, and Al added (including water present in aqueous solutions) varies according to the specific alkoxide being reacted. Preferably, a molar ratio of water:alkoxide from about 0.1:1 to 10:1 is used. However, ratios close to 4:1 for zirconium(alkoxide)₄ and titanium(alkoxides)₄ can also be used with success. The amount of water utilized in the reaction is that calculated to hydrolyze the alkoxide in the reaction mixture. A ratio lower than that needed to hydrolyze the alkoxide species will result in a partially hydrolyzed material, which in most cases will reach a gel point at a much slower rate, depending on the aging procedure and the presence of atmospheric moisture.

The addition of acidic or basic reagents to the alkoxide medium can have an effect on the kinetics of the hydrolysis and condensation reactions, and the microstructure of the oxide/hydroxide matrices derived from the alkoxide precursor which entraps or incorporates the soluble metal and promoter reagents. It is preferred that a pH within the range of from 1 to 12 is used, with a pH range of from 1 to 6 being more preferred.

After reacting to form an alcogel, as described above, it may be necessary to complete the gelation process with some aging of the gel. This aging can range from one minute to several days. Generally, the alcogels are aged at room temperature in air for at least several hours.

Removal of solvent from the alcogels is accomplished by several methods. Removal by vacuum drying or heating in air results in the formation of a xerogel. An aerogel of the material can typically be formed by charging in a pressurized system such as an autoclave. The solvent-containing gel is placed in an autoclave where it can be contacted with a fluid above its critical temperature and pressure by allowing supercritical fluid to flow through the gel material until the solvent is no longer being extracted by the supercritical fluid. In performing this extraction to produce an aerogel material, various fluids can be utilized at their critical temperature and pressure. For instance, fluorochlorocarbons typified by Freon® fluorochloromethanes (e.g., Freon® 11 (CCl₃F), 12 (CCl₂F₂) or 114 (CClF₂CClF₂), a ammonia and carbon dioxide are all suitable for this process. Typically, the extraction fluids are gases at atmospheric conditions, so that pore collapse due to the capillary forces at the liquid/solid interface are avoided during drying. The resulting material should, in most cases, possess a higher surface area than the non-supercritically dried materials.

The xerogels and aerogels thus produced may be described as precursor salts dispersed in an oxide or oxyhydroxide matrix. The hydroxyl content is at this point undefined; a theoretical maximum corresponds to the valence of central metal atom. The molar H₂O:alkoxide ratio can also impact the final xerogel stoichiometry so that there will be residual —OR groups in the unaged gel. However, reaction with atmospheric moisture will convert these to the corresponding —OH, and —O groups upon continued polymerization and dehydration. Aging, even under inert conditions, can also effect the condensation of the —OH, eliminating H₂O, through continuation of cross linking and polymerization, i.e., gel formation.

Xerogels and Aerogels from Inorganic Metal Colloids

Alternatively, one or more inorganic metal colloids may be used as starting material for preparing the gels. These colloids include colloidal alumina sols, colloidal ceria sols, colloidal zirconia sols or their mixtures. The colloidal sols are commercially available from well-known suppliers. There are also several methods of preparing colloids, as described in “Inorganic Colloid Chemistry”, Volumes 1, 2 and 3, J. Wiley and Sons, Inc., 1935. Colloid formation involves either nucleation and growth, or subdivision or dispersion processes. For example, hydrous titanium dioxide sols can be prepared by adding ammonia hydroxide to a solution of a tetravalent titanium salt, followed by peptization (re-dispersion) by dilute alkalis. Zirconium oxide sol can be prepared by dialysis of sodium oxychlorides. Cerium oxide sol can be prepared by dialysis of a solution of ceric ammonium nitrate.

Commercially available alkoxides, such as tetraethylorthosilicate and Tyzor® organic titanate esters, may be used. However, alkoxides may also be prepared by various well-known routes. Examples include direct reaction of zero valent metal with alcohols in the presence of a suitable catalyst; and the reaction of metal halides with alcohols. Alkoxy derivatives can be synthesized by the reaction of the alkoxide with alcohol in a ligand interchange reaction. Direct reactions of metal dialkamides with alcohol also form alkoxide derivatives. Additional examples are described in D. C. Bradley et al., “Metal Alkoxides” (Academic Press, 1978).

In one especially preferred method of preparing a chromium-based catalyst, pre-formed colloidal sols in water, or aquasols, are used. The aquasols are comprised of colloidal particles ranging in size from 2 to 50 nanometers. In general, the smaller primary particle sizes (2 to 5 nm) are preferred. The pre-formed colloids contain from 10 to 35 weight % of colloidal oxides or other materials, depending on the method of stabilization. Generally, after addition of the active (for the partial oxidation reactions, either as a catalyst or promoter) metal components, the final de-stabilized colloids can possess from about 1 to 35 weight % solids, preferably from about 1 to 20 weight percent.

The colloidal oxides or their mixtures are destabilized during the addition of soluble salts of the primary and promoter cation species by the addition of acids or bases or by solvent removal, both of which alter pH. These changes modify the colloidal particle's electrical double layer. Each colloidal particle possesses a double layer when suspended in a liquid medium. For instance, a negatively charged colloid causes some of the positive ions to form a firmly attached layer around the surface of a colloid. Additional positive ions are still attracted by the negative colloid, but now they are repelled by the primary positive layer as well as the positive ions, and form a diffuse layer of counterions. The primary layer and the diffuse layer are referred to as the double layer. The tendencies of a colloid to either agglomerate (flocculate and precipitate) or polymerize when destabilized will depend on the properties of this double layer. The double layer, and resulting electrostatic forces can be modified by altering the ionic environment, or pH, liquid concentration, or by adding a surface active material directly to affect the charge of the colloid.

Once the particles come in close enough contact when destabilized, polymerization and crosslinking reaction between surface functional groups, such as surface hydroxyls, can occur. In this invention, the colloids, which are originally stable heterogeneous dispersions of oxides and other species in solvents, are destabilized to produce colloidal gels. Destabilization is induced, in some cases, by the addition of soluble salts, e.g., chlorides or nitrates, which change the pH and the ionic strength of the colloidal suspensions; by the addition of acids or bases; or by solvent removal. pH changes generally accompany the addition of soluble salts; in general, this is preferred over solvent removal. Generally, a pH range of from about 0 to about 12 can be used to destabilize the colloids; however, very large extremes in pH (such as pH 12) can cause flocculation and precipitation. For this reason, a pH range of from about 2 to 8 is preferred.

The medium utilized in this process is typically aqueous, although non-aqueous colloids can also be used. The additional metal or inorganic reagents (i.e., salts of Cr or promoters) used should be soluble in the appropriate aqueous and non-aqueous media.

Freeze Drying to Form the Solid Catalyst Composition

Removal of solvent from the gels can be accomplished by several methods as described above to prepare either an aerogel or xerogel. Freeze drying procedures can accommodate several catalyst compositions, and are useful if the catalyst precursors are soluble in water or other solvent which can be rapidly (<1 minute) frozen. Precursor salts are dissolved in an appropriate amount of solvent to form a solution or fine colloid. The solution is then rapidly cooled and frozen by immersion in a suitable medium, such as liquid nitrogen. If the solution is rapidly frozen, the salts and other components will remain intimately mixed and will not segregate to any significant degree. The frozen solid is transferred to a freeze drying chamber. The solution is kept frozen while water vapor is removed by evacuation. In the present studies, a two section Virtis freeze drying unit was employed. Refrigerated shelves were used to prevent thaw-out of the frozen solids during evacuation.

Spray Drying to Form the Solid Catalyst Composition

Spray drying procedures involve the use of solutions, colloids or slurries containing catalyst precursors or catalyst compounds. The technique consists of atomization of these liquids (usually but not exclusively aqueous) into a spray, and contact between spray and drying medium (usually hot air) resulting in moisture evaporation. The drying of the spray proceeds until the desired moisture content in the dried particles is obtained, and the product is recovered by suitable separation techniques (usually cyclone separation). A detailed description of spray drying methods can be found in “Spray Drying Handbook”, 4th edition by K Masters (Longman Scientific and Technical, John Wiley and Sons, N.Y) c. 1985.

Spray Roasting to Form the Solid Catalyst Composition

Spray roasting also involves the use of solutions or colloids, but generally involves drying and calcination (at higher temperatures) in one process step to produce catalyst powders. Suitable spray roasting techniques are described in U.S. Pat. No. 5,707,910.

### EXAMPLES

The catalyst compositions are given in atomic ratios except where otherwise noted.

### Example 1

### Cr_{0.1}La_{0.9}Ox

An aqueous solution of Cr₃(OH)₂(CH₃CO₂)₇ (Aldrich 31,810-8) (2.22 mL, 2.5603 M in Cr) and aqueous La(NO₃)₃ (42.78 mL, 1.1955 M) were simultaneously added to a 150 mL petri dish with gentle swirling. The entire solution was rapidly frozen with liquid nitrogen and dried as a frozen solid under vacuum for several days to produce a freeze dried powder. The freeze dried material was heated in air at 350° C. for 5 hours prior to pelletization and use. The final catalyst had a nominal composition of Cr_{0.1}La_{0.9}Ox.

### Example 2

### Cr_{0.025}Mg_{0.975}Ox

A magnesium methoxide solution (68.767 mL, 0.3495 M) diluted with 50 volume % ethanol (punctilious) was added to a 150 mL petri dish with gentle swirling under an inert N₂ atmosphere. In a subsequent addition, aqueous Cr₃(OH)₂(CH₃CO₂)₇ solution (1.233 mL, 0.5 M in Cr) was introduced to the petri dish while it was gently swirled. Following the addition of the aqueous solutions, a gel point was realized and a homogeneous gel formed which was nearly white in color. The gel was allowed to age 8 days in air and then dried under vacuum at 120° C. prior to use. The final xerogel had a nominal composition of Cr_{0.025}Mg_{0.975}Ox.

### Example 3

### Cr_{0.2}Mg_{0.4}Si_{0.4}Ox

A magnesium methoxide solution (57.474 mL, 0.669 M) and a tetraethylorthosilicate (TEOS) solution (diluted with ethanol to 60 volume % TEOS, 40 volume % ethanol) were simultaneously added to a 150 mL petri dish with gentle swirling under a nitrogen atmosphere. In a subsequent step, aqueous Cr₃(OH)₂(CH₃CO₂)₇ solution (7.846 mL, 2.5603 M) was added. A white gel formed, and was aged for 5 days, dried under vacuum at 120° C. for 5 hours prior to use. The final xerogel had a nominal composition of Cr_{0.2}Mg_{0.4}/Si_{0.4}Ox.

### Example 4

### Cr_{0.1}Ce_{0.9}Ox

An aqueous solution of Cr₃(OH)₂(CH₃CO₂)₇ (1.375 mL, 2.560 M in Cr) and aqueous solution of Ce(NO₃)₃.6H₂O (43.625 mL, 0.7261 M) were simultaneously added to a 150 mL pyrex petri dish with gentle swirling. The entire solution was rapidly frozen with liquid nitrogen and dried as a frozen solid under vacuum for several days to produce a freeze dried powder. The freeze dried material was heated in air at 350° C. for 5 hours prior to pelletization and use. The final catalyst had a nominal composition of Cr_{0.1}Ce_{0.9}Ox.

### Example 5

### Cr_{0.1}Sm_{0.9}Ox

An aqueous solution of Cr₃(OH)₂(CH₃CO₂)₇ (0.969 mL, 2.560 M in Cr) and an aqueous solution of samarium nitrate (44.031 mL, 0.5069 M), the solution was formed using water and nitric acid to bring the final pH to 0.24 to dissolve Sm(NO₃)₃.6H₂O, were simultaneously added to a 150 mL pyrex petri dish with gentle swirling. The entire solution was rapidly frozen with liquid nitrogen and dried as a frozen solid under vacuum for several days to produce a freeze dried powder. The freeze dried material was heated in air at 350° C. for 5 hours prior to pelletization and use. The final catalyst had a nominal composition of Cr_{0.1}Sm_{0.9}Ox.

### Example 6

### Cr_{0.25}Co_{0.25}Ti_{0.5}Ox

A titanium n-butoxide solution in ethanol (2.67 mL, 60 volume %) was added to a 150 mL petri dish under an inert nitrogen atmosphere with gentle swirling. In a second step, an ethanolic solution of anhydrous CoCl₂ (2.342 mL, 1.00 M), glacial acetic acid (0.140 mL), H₂O (1.182 mL) and an ethanolic solution of chromium (III) acetylacetonate (93.667 mL, 0.03 M) were simultaneously added. A gel point was realized following the addition of the aqueous reagents, and the red, opaque gel which formed and was aged for at least 24 hours prior to drying under vacuum at 120° C. for five hours. The final xerogel had a nominal composition of Cr_{0.25}Co_{0.25}Ti_{0.5}Ox.

### Example 7

### Cr_{0.2}Au_{0.025}Al_{0.775}Ox

An aqueous AuCl₃ solution (28.822 mL, 0.03 M) was combined with an aqueous solution of Cr₃(OH)₂(CH₃CO₂)₇ (4.095 mL, 1.689 M in Cr) and an aqueous Al₂ O₃ colloid (5.742 mL, 4.668 M (as Al)) in a 150 mL petri dish with gentle swirling. A NaOH solution (1.340 mL, 0.01 M) was added both for Na content and to destabilize the colloid and induce gellation by altering pH. A red brown gel formed, and the material was aged for at least two days prior to drying under vacuum at 120° C. for five hours. The final xerogel had a nominal composition of Cr_{0.2}Au_{0.25}Al_{0.775}Ox.

### Example 8

### Cr_{0.025}Au_{0.025}Mg_{0.95}Ox

A magnesium methoxide (Mg(OCH₃)₂) solution (47.353 mL, 0.3495 M) formed by combining magnesium methoxide with 50 volume % ethanol and 0.02 M AuCl₃ (21.776 mL) in absolute ethanol were simultaneously added to a 150 mL petri dish with gentle swirling under a nitrogen atmosphere. In a subsequent addition, an aqueous solution containing Cr₃(OH)₂(CH₃COO)₇ (0.871 mL, 0.5M in Cr) was added. A gel formed, and the dark gel, after aging for at least three days, was dried at 120° C. under vacuum for 5 hours. The final xerogel had a nominal composition of Cr_{0.025}Au_{0.025}Mg_{0.95}Ox.

### Example 9

### 10% Cr 1% Li 27% La/α-Al₂O₃

An aqueous solution of LiNO₃ (1.762 g) in distilled water was added by the incipient wetness technique to an alpha-alumina support (19.723 g, calcined at 900° C. overnight before use). The solids were dried at 110° C. for two hours. An aqueous solution of La(NO₃)₃.6H₂O (22.134 g) in distilled water was added by the incipient wetness technique to the dried solids. The solids were again dried at 110°C. for two hours. An aqueous solution of Cr(NO₃)₃.9H₂O (23.087 g) in distilled water was added by the incipient wetness technique to the dried solids. Finally, the material was dried at 110°C. for two hours followed by calcination at 900° C. overnight. The final catalyst had a nominal composition of (in wt %)10% Cr 1% Li 27% La Ox/α-Al₂O₃.

### Example 10

### 2% Cr 1% Li 27% La/α-Al₂O₃

An aqueous solution of LiNO₃ (1.762 g) in distilled water was added by the incipient wetness technique to an alpha-alumina support (22.123 g, calcined at 900° C. overnight before use). The solids were dried at 110° C. for two hours. An aqueous solution of La(NO₃)₃.6H₂O (22.134 g) in distilled water was added by the incipient wetness technique to the dried solids. The solids were again dried at 110° C. for two hours. An aqueous solution of Cr(NO₃)₃.9H₂O (4.617 g) in distilled water was added by the incipient wetness technique to the dried solids. Finally, the material was dried at 110° C. for two hours followed by calcination at 900° C. overnight. The final catalyst had a nominal composition of(wt %) 2% Cr 1% Li 27% La Ox α-Al₂O₃.

### Example 11

### Freeze-Dried Cr₂O₃

An aqueous solution of Cr₃(OH)₂(CH₃CO₂)₇ (100 mL, 2.5603 M in Cr) was added a 150 mL petri dish and rapidly frozen with liquid nitrogen. The frozen solid was dried under vacuum for several days (approximately 7 days) to produce a freeze dried powder. The freeze dried material was heated in air at 350° C. for 5 hours and 525° C. for 1 hour prior to use.

### Example 12

### Aerogel Cr₂O₃

Aerogel synthesis using a sol gel chemistry (Cr₂O₃ derived from the reaction of CrO₃ and methanol to produce a Cr₂O₃ gel, followed by supercritical extraction to produce a high surface area oxide (>500 m²/g). 16 g of chromium trioxide (CrO₃, Aldrich 23, 265-7) was dissolved in 24 ml of water, and added to 420 ml of methanol and 36 ml of additional water. Three of these combined solutions were loaded into a 1 liter autoclave, which was sealed and heated over a four hour time period to 300° C. and 3400 psig. After holding at this temperature and pressure for 120 minutes, the pressure was vented to 1000 psig over 2 hours while maintaining 300° C. Pressure was finally vented to 1 atmosphere by bleeding at a rate of 10 psig per minute while maintaining 300° C., and the material was allowed to cool overnight. A Cr₂O₃ aerogel is formed by this procedure (reaction of CrO₃+CH₃OH→Cr₂O₃+other oxidation products of methanol (e.g., formaldehyde)). The surface area of materials formed by this procedure 537 m²/g, as determined by N₂ BET analysis, and is X-ray (diffraction) amorphous.

### Example 13

### “Newport Chrome” Chromium Oxide (Comparative Example)

A commercially prepared catalyst manufactured by DuPont at the Holly Run site, by the pyrolysis of ammonium dichromate, (NH₄)₂Cr₂O₇, was tested for comparative purposes.

### Example 14

### CO_{0.2}Cr_{0.8}Ox

12 ml of Co(NO₃)₂.6H₂O 1.0826M was combined with 20.30 ml of an aqueous solution of Cr₃(OH)₂(CH₃CO₂)₇(2.5603M in Cr) to form an aqueous solution which was frozen, freeze-dried and calcined as described in Example 11.

### Example 15

### Co_{0.8}Cr_{0.2}Ox

48 ml of Co(NO₃)₂.6H₂O (Aldrich, 23,037-5), 1.0826M was combined with 5.07 ml of an aqueous solution of Cr₃(OH)₂(CH₃CO₂)₇ (2.5603M in Cr) to form an aqueous solution which was then frozen, freeze-dried and calcined as described in Example 11.

### Example 16

### Co_{0.5}Cr_{0.5}Ox

30 of Co(NO₃)₂.6H₂O (Aldrich, 23,037-5), 1.0826M was combined with 12.69 ml of an aqueous solution of Cr₃(OH)₂(CH₃CO₂)₇ (2.5603M in Cr) to form an aqueous solution which was then frozen, freeze-dried and calcined as described in Example 11.

### Example 17

### CoOx (Comparative Example)

60 ml of a solution containing Co(NO₃)₂.6H₂O (Aldrich, 23,037-5) 1.0826 M was rapidly frozen in liquid nitrogen, placed in a freeze dryer (Virtis Corporation, shelves refrigerated to 0°C.) and evacuated to dryness over a period of 5-7 days, or until completely dry. The material was calcined in air according to the following schedule: 5° C./min to 525° C., 525° C. for 1 hour; 10° C./min to room temperature. The material was pelletized and sieved prior to the reactor evaluation. The cobalt oxide catalyst was evaluated as described in the following section entitled “Test Procedure.” This composition is identified in Table 9, and the performance results are shown in Table 10. The beneficial effects of adding chromium to cobalt catalyst compositions, as described below, are also apparent in Table 10. The preferred Cr-Co Ox catalysts which exhibit reduced carbon deposition are designed with lower cobalt levels and the addition of basic rare earth, alkaline or alkaline earth components.

Test Procedure

Catalysts were evaluated in a 25 cm long quartz tube reactor equipped with a co-axial, quartz thermocouple well, resulting in a 4 mm, reactor i.d. The void space within the reactor was packed with quartz chips. The catalyst bed was positioned with quartz wool at approximately mid-length in the reactor. A three point, K type, thermocouple was used with the catalyst's “hot spot”, read-out temperature reported as the run temperature. The catalyst bed was heated with a 4 inch (10.2 cm), 600 W band furnace at 90% electrical output. Mass flow controllers and meters regulated the feed composition and flow rate. Prior to start-up, the flows were checked manually with a bubble meter and then the feed composition was reconfirmed by gas chromatographic. analysis. The flow rates of all the meters were safety interlocked and their measurements were checked electronically by the mass flow meters every second. All runs were performed at a CH₄:O₂ feed ratio of 2: 1, safely outside of the flammable region. Specifically, the feed contained (in volume %) 30% CH₄, 15% O₂ and 55% N₂. Experiments were conducted at 5 psig (136 kPa). The reactor effluent was analyzed by a gas chromatograph (g.c.) equipped with a thermal conductivity detector. The feed components (CH₄, O₂, N₂) and potential products (CO, H₂, CO₂, and H₂O) were all well resolved and reliably quantified by two chromatography columns in series consisting of 5A molecular sieve and Haysep T. Mass balances of C, H, and O all closed at 98-102%. Runs were conducted over two operating days, each with 6 hours of steady state, run time.

The results of testing the catalyst compositions of Examples 1 -16 are shown in Table 1. Catalyst performance is reported at steady state and showed no evidence of catalyst deactivation after 12 hours, according to g.c. analysis.

TABLE 1
Catalyst Performance

| Example | Catalyst | | | Temp. | | % CH₄/O₂ | % CO/H₂ | | |
|---|---|---|---|---|---|---|---|---|---|
| No. | Composition | V (mL) | Wt. (g) | ° C. | GHSV × 10⁴ | Conv. | Sel. | H₂:CO | % Coke |
| 1 | Cr_{0.1}La_{0.9}Ox | 2 | 2.1417 | 770 | 6.1 | 58/100 | 83/73 | 1.8 | 0.08 |
| 2 | Cr_{0.025}Mg_{0.975}Ox | 2 | 0.9024 | 710 | 6.1 | 45/100 | 74/48 | 1.3 | 2.99 |
| 3 | Cr_{0.2}Mg_{0.4}Si_{0.4}Ox | 2 | 1.3851 | 875 | 6.1 | 64/100 | 93/50 | 1.1 | 1.83 |
| 4 | Cr_{0.1}Ce_{0.9}Ox | 0.4 | 0.5972 | 860 | 3.045 | 36/100 | 49/45 | 1.8 | n.d. |
| 5 | Cr_{0.1}Sm_{0.9}Ox | 0.4 | 0.5350 | 870 | 3.045 | 48/100 | 65/66 | 2.0 | 0.17 |
| 6 | Co_{0.25}Cr_{0.25}Ti_{0.5}Ox | 2 | 1.0605 | 980 | 6.1 | 82/100 | 93/92 | 2.0 | n.d. |
| 7 | Au_{0.025}Cr_{0.2}Al_{0.775}Ox | 0.7 | 0.5685 | 911 | 17.4 | 28/92 | 60/25 | 0.8 | 9.98 |
| 8 | Au_{0.025}Cr_{0.025}Mg_{0.95}Ox | 2 | 0.9560 | 915 | 6.1 | 48/100 | 84/44 | 1.0 | 22.19 |
| 9 | 10%Cr,1%Li/27%La/α-Al₂O₃* | 0.9 | 1.0235 | 850 | 6.1 | 90/100 | 97/90 | 1.9 | n.d. |
| 10 | 2%Cr,1%Li,27%La/α-Al₂O₃* | 0.4 | 0.5327 | 830 | 3.045 | 90/100 | 96/93 | 1.9 | 2.69 |
| 11 | Cr₂O₃ (freeze dried) | 2 | 2.3529 | 670 | 6.1 | 72/100 | 91/85 | 1.9 | n.d. |
| 12 | Cr₂O₃ (Aerogel) | 0.4 | 0.2180 | 550 | 3.045 | 21/99 | 0/0 | n/a | n.d. |
| 13 | Cr₂O₃ (Newport) | 0.4 | 0.0778 | 655 | 30.5 | 29/64 | 70/30 | 0.86 | n.d. |
| 14 | Co_{0.2}Cr_{0.8}Ox | 2 | 2.1793 | 630 | 6.1 | 96/100 | 98/97 | 1.98 | 0.39 |
| 15 | Co_{0.8}Cr_{0.2}Ox | 2 | 2.2806 | 670 | 6.1 | 93/100 | 96/96 | 2.00 | n.d. |
| 16 | Co_{0.5}Cr_{0.5}Ox | 2 | 1.9917 | 650 | 6.1 | 95/100 | 98/97 | 1.98 | n.d. |

n.d. = none detected
*wt %

The recovered (after use) Cr₂O₃ catalyst of Example 11 showed no weight loss after thermal gravimetric analysis in air at 600° C. to 700° C.; no significant carbon deposition (coking) is apparent using this analytical method.

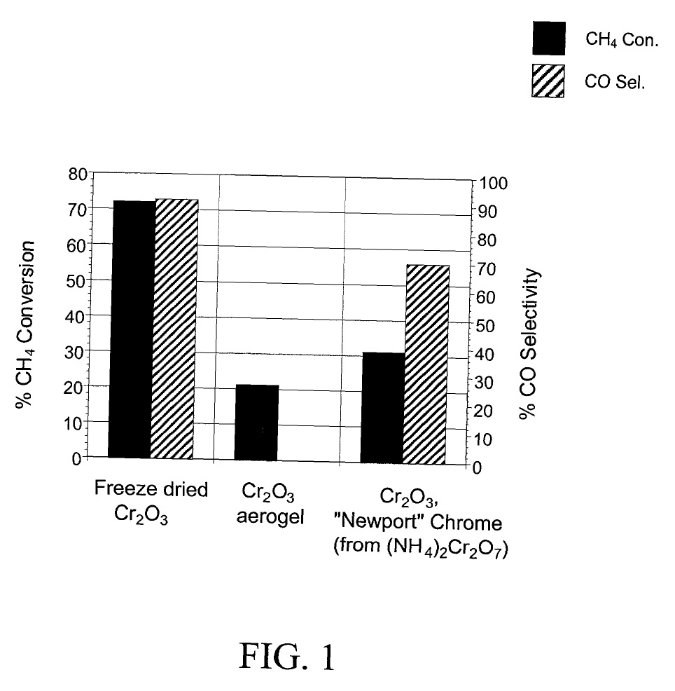

With reference to FIG. 1, comparing catalyst performance of the catalysts from Examples 11, 12 and 13, it can be appreciated that the catalyst preparation procedure has a major impact on catalyst performance. All three of these catalysts are nominally chromium oxide, yet demonstrate major differences in performance which can be seen in Table 1. The catalyst of Example 11 was prepared by freeze drying chromium oxide precursors (e.g., chromium hydroxide acetate), followed by calcination at 525° C., which appears to produce a catalyst precursor with superior (best) performance (i.e., highest conversion and selectivity). The catalyst of Example 12 was prepared by aerogel synthesis using a sol gel chemistry (Cr₂O₃ derived from the reaction of CrO₃ and methanol to produce a Cr₂O₃ gel, followed by supercritical extraction to produce a high surface area oxide (>500m²/g). The catalyst of Example 13 is a commercially available catalyst, “Newport Chrome,” manufactured by DuPont at the Holly Run site. It is commercially prepared by pyrolyzing ammonium dichromate, (NH₄)₂Cr₂O₇. Chromium oxide prepared by freeze drying an aqueous solution of chromium hydroxide acetate, followed by calcination in air at 525° C., is clearly the most active and selective catalyst, as shown in FIG. 1 and in Table 2, although this result could not have been predicted from previous work with chromium catalysts. Other major differences in performance between the catalysts of Examples 11-13 are also noted in Table 2. The “coke” and carbon content of the catalysts were determined on samples which were evaluated, and indicated in the last column of the table. The first number is derived from TGA analysis, and is the percentage weight loss of the sample above 600° C. in air. The second number is determined by an elemental analysis technique involving combustion of the catalyst and analysis of CO/CO₂ which is produced.

TABLE 2
Millisecond Contact Time Reactor Data,^{a} ChromiumOxide

| | Vol | | Temp. | | % CH₄/O₂ | % CO/H₂ | H₂:CO | |
|---|---|---|---|---|---|---|---|---|
| Catalyst | (mL) | Wt. (g) | (° C.) | GHSV × 10⁴ | Conv. | Sel. | Ratio | % Coke |
| Cr₂O₃ (freeze dried) | 2.0 | 2.3529 | 670 | 6.1 | 72/100 | 91/85 | 1.90 | n.d^{b}/0.32 |
| Cr₂O₃ (Aerogel) | 0.4 | 0.2180 | 550 | 3.0 | 21/99 | 0/0 | n/a | n.d^{b} |
| Cr₂O₃ (Newport) | 0.4 | 0.0778 | 655 | 30 | 29/64 | 70/30 | 0.86 | 0.05 |
| Co_{0.2}Cr_{0.8}Ox | 2.0 | 2.1793 | 630 | 6.1 | 96/100 | 98/97 | 1.98 | 0.39/2.2 |
| Co_{0.5}Cr_{0.5}Ox | 2.0 | 1.9917 | 650 | 6.1 | 95/100 | 98/97 | 1.98 | n.d^{b}/5.2 |
| Co_{0.8}Cr_{0.2}Ox | 2.0 | 2.2806 | 670 | 6.1 | 93/100 | 96/96 | 2.00 | n.d.^{b}/21.6 |

^{a}Feed: 30% CH₄, 15% O₂, 55% N₂
^{b}not detected

The conventional view is that chromium promoters or additives promote non-selective reaction pathways for alkane oxidation reactions using molecular oxygen, O₂. Therefore, the selective behavior of chromium oxide-based compositions as catalysts for the partial oxidation of methane to CO and H₂, as disclosed herein, is unexpected and even surprising. In one inventor's experience with n-butane oxidation, for example, it was observed that chromium promoters in vanadium phosphorus oxide catalysts increased catalyst activity at the expense of selectivity. In these cases the catalysts were compared at the same percent conversion of reactant. A similar trend was also noted by Oganowski, W. et al. (“Promotional Effect of Molybdenum, Chromium and Cobalt on a V-Mg-O catalyst in oxidative dehydrogenation of ethylbenzene to styrene,” Applied Catalysis A: General 136 (1996) 143-159.) At page 156 of that reference, the reaction chemistry is the oxidative dehydrogenation of ethylbenzene to styrene: “The molybdenum, chromium or cobalt doped V-Mg-O catalyst changes its activity and selectivity in the oxidative dehydrogenation of ethylbenzene. The specific activity decreases in the direction Cr,Co>Cr>Co>Mo while the selectivity increases in the direction: Cr>>Co,Cr,Co>Mo.” This suggests that Cr would not serve as a selective catalyst for a process involving C-H activation, such as CH₄ partial oxidation, and is contrary to the inventors' present findings.

Although the reasons for these performance differences are under investigation, the selectivity changes may be related to the surface areas of the catalyst generated. Catalysts possessing the highest surface areas (i.e., a chromium oxide aerogel) also possess the lowest light-off temperatures and exhibit no selectivity to CO/H₂. This suggests that an increase in the number of sites for CO adsorption results in slower desorption from the catalyst surface, allowing for oxidation of CO. In the millisecond contact time reaction regime, a lower surface area catalyst possessing a limited number of active sites may actually be preferred for selective oxidation pathways.

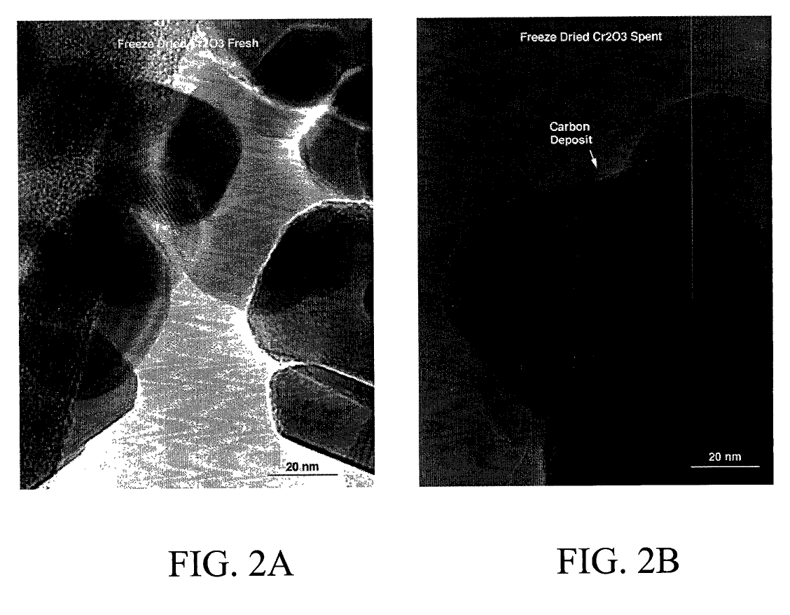

Another important observation for the freeze dried catalyst systems is the near-absence of carbon deposition on the catalyst surfaces. This is clearly indicated for the pure chromium oxide freeze dried catalyst in the transmission electron microscopy (TEM) studies. FIG. 2A shows the crystal structure of the chromium oxide catalyst as prepared in Example 11. The freeze dried chromium oxide is comprised of highly crystalline powder containing well-faceted chromium oxide crystallites. Powder X-ray diffraction confirms the well-crystallized nature of this material. No change in catalyst appearance is apparent after reactor evaluation during an eight hour period, indicating stability of the material on stream over short time intervals. FIG. 2B shows the crystal structure of a sample taken after 6 hours on stream, indicating that there was no apparent change in crystallite size or morphology with time on stream in a reactor. After 6 hours on stream there is little carbon build-up (coking). A carbon deposit is indicated by the arrow in FIG. 2B. The surprisingly low carbon deposition may also be related to the lower surface area of the catalyst and the highly faceted, defect-free nature of the catalyst surface. Low carbon deposition and stability on stream (i.e., lack of sintering of chromium oxide particles) are very favorable catalyst properties for syngas catalysts.

X-ray diffraction (XRD) analysis of the Co/Cr materials of the representative catalysts of Examples 14-16 revealed that the Co_{0.2}Cr_{0.8} Ox catalyst comprised, in the catalyst as calcined (heated in air), a mixture of CoCr₂O₄ (cubic spinel phase) and Cr₂O₃ (eskolaite, hexagonal/rhombohedral phase). In the final catalyst, after an 8 hour evaluation as described in Table 2, XRD analysis revealed Cr₂O₃ and possibly Co metal or a chromium carbide phase. Low carbon formation is a very unusual, unexpected, and advantageous feature of many of the Cr₂O₃ catalyst systems described herein.

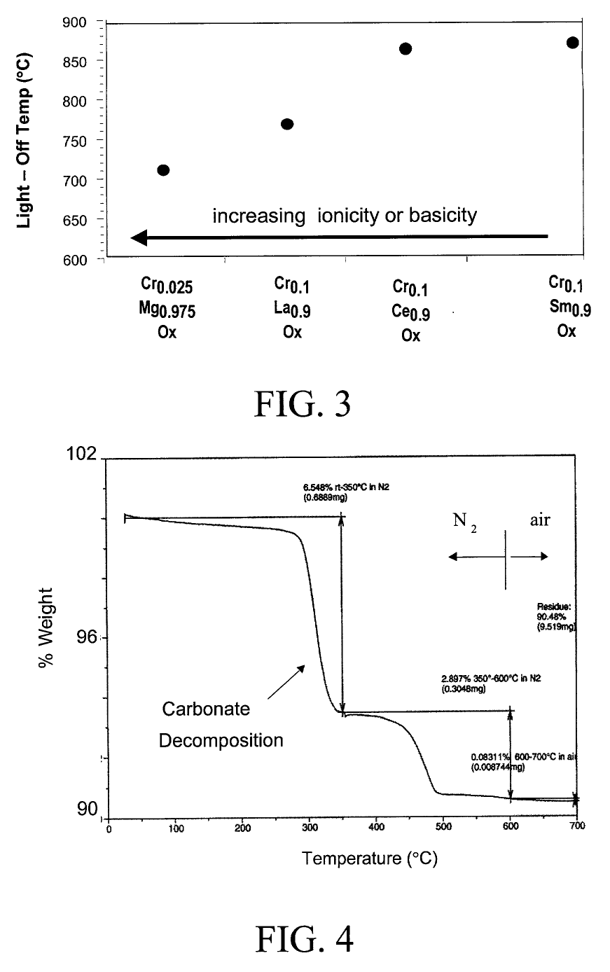

Additional catalyst systems were investigated to study trends in C-H activation. In this case, a series of rare earth promoted catalysts were synthesized and tested. FIG. 3 is a graph showing trends in light-off temperature and basicity/ionicity of representative “support” matrix compositions (i.e., Cr_{0.25}Mg_{0.975}Ox; Cr_{0.1}La_{0.9}Ox; Cr_{0.1}Ce_{0.9} Ox; and Cr_{0.1}Sm_{0.9}Ox from Examples 1, 2, 4 and 5.). The predicted ionicity or basicity of the compositions increases from right to left along the x-axis of the graph. These systems were chosen for their thermal stability. In addition, rare earth oxide base catalysts have been reported for methane coupling-type reactions. The basicity of these rare earth oxide systems may facilitate C-H activation. Trends in light-off temperature, or ignition temperature, suggest that this may be the case. A lanthanum chromium oxide compound (comprised of La₂Cr₂O₆+Cr₂O₃ in powder X-ray diffraction studies) possesses the lowest light-off or ignition temperature. A plot of the light-off temperature versus the expected basicity or ionicity of the rare earth component shows a correlation which suggests C-H activation may be related to this property.

Thermogravimetric analysis (TGA) studies also indicate low carbon deposition for the rare earth oxide based chromium catalysts, as shown in FIG. 4 for La_{0.1}Cr_{0.9}Ox(Cr₂O₃+La₂Cr₂O₆ by X-ray diffraction), prepared similarly to the method described in Example 11. In FIG. 4, the arrow at about 300° C. indicates a temperature region where the catalyst undergoes carbonate decomposition and appreciable weight loss occurs. Carbon deposition, as indicated by the weight loss at about rt-350° C. in N₂ is 6.548% (0.6889 mg). The weight loss from about 350-600° C. is 2.897% (0.3048 mg), and from about 600-700° C. is 0.08311% (0.008744 mg). TGA analysis of weight loss in air (>600° C.) indicates <<1 wt % carbon deposition for these catalyst systems after eight hours on stream (i.e., <0.07 wt % upon oxidation in air from 600-700° C. for La_{0.1}Cr_{0.9}Ox).

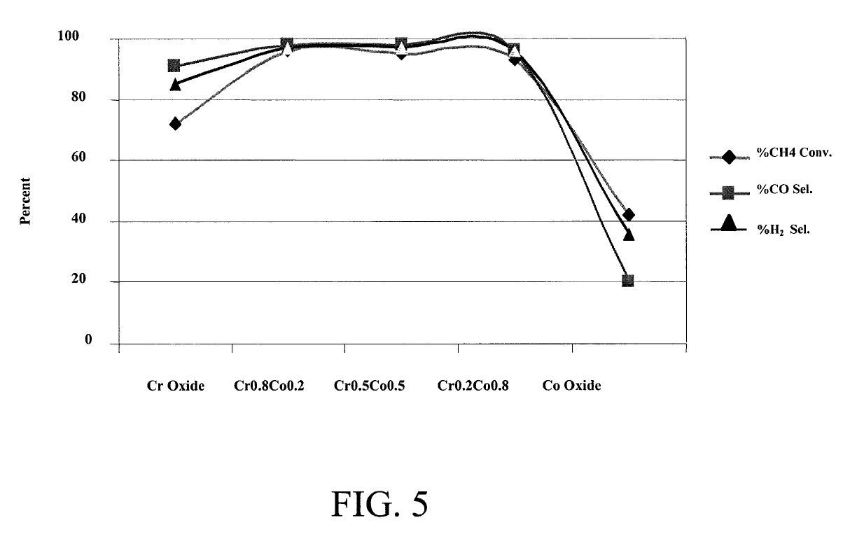

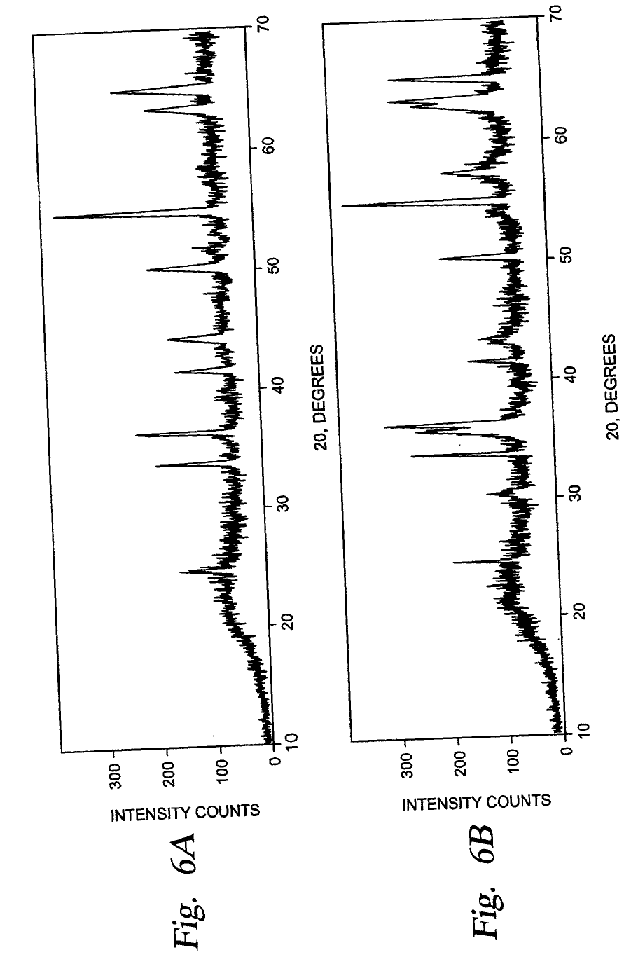

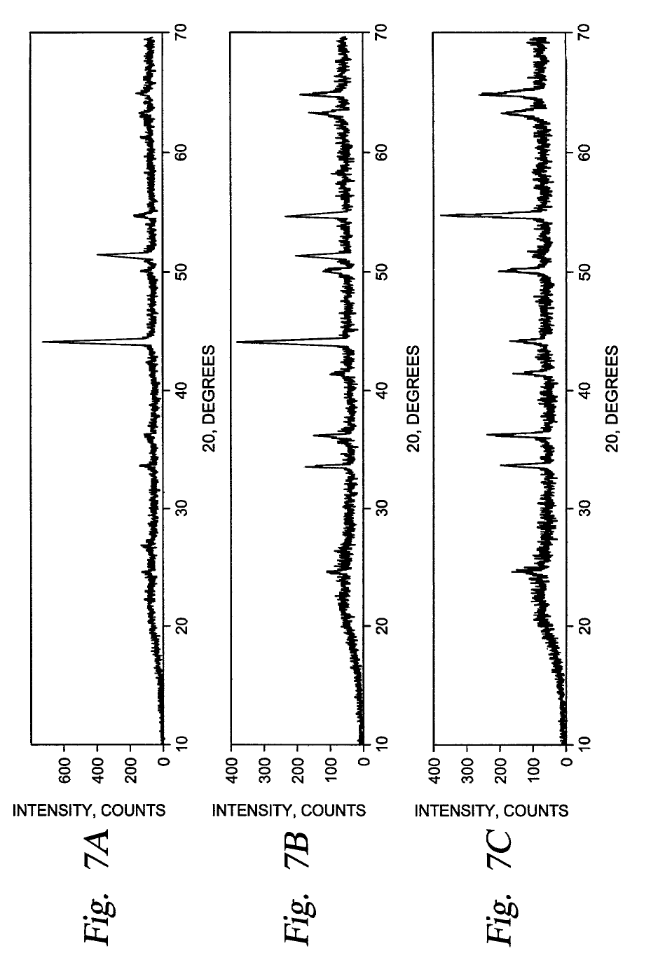

A series of cobalt-containing chromium oxides are particularly interesting for this reaction chemistry. Initial studies on a Co_{0.25}Cr_{0.25}Ti_{0.5}Ox system prepared using sol gel methods indicated that this catalyst was a promising catalyst system. A “freeze-dried” variant of this catalyst system, without titanium oxide, and prepared similar to the procedure in Example 1, exhibits the highest activity and selectivity, as shown in FIG. 5 and Table 2. FIG. 5 is a graph showing the reaction chemistry for several representative ternary freeze dried chromium oxides containing chromium and cobalt, and for chromium oxide and cobalt oxide alone. The reaction conditions included 30% methane feed, 15% O₂ feed, 55% N₂ atmosphere, 6 hours on stream. X-ray diffraction analysis indicated the presence of Cr₂O₃ matrix and varying proportions of cobalt in the catalyst compositions tested. The low conversion and selectivity demonstrated by cobalt oxide in FIG. 5 shows the beneficial effect of including chromium in the catalyst composition. This figure also indicates an optimal composition range for the specified reaction conditions (i.e., feed composition and flow rate of about 6.1×10⁴ GHSV). As shown in the X-ray diffraction data of FIGS. 6 and 7, the cobalt chromium oxide materials consist of the cubic spinel (CoCr₂O₄) dispersed in a Cr₂O₃ matrix (hexagonal/rhombohedral phase, eskolaite). Before reactor evaluation (FIG. 6B) X-ray diffraction indicates a representative cobalt chromium oxide composition contains CoCr₂O₄ cubic spinel and Cr₂O₃. Following reaction in situ (i.e., on stream) the catalyst precursor CO_{0.2} Cr_{0.8}Ox is reduced to cobalt metal and chromium oxide, as shown in FIG. 6A. This is not surprising considering the higher temperatures used in this methane oxidation reaction. FIGS. 7A-C contain the X-ray diffraction data for “reactor evaluated” catalysts having the following compositions, respectively: Co_{0.2}Cr_{0.8}Ox, Co_{0.5}Cr_{0.8}Ox, and Co_{0.8}Cr_{0.2}Ox. These compositions were prepared as described in Examples 14-16. Each of these samples show Co metal and Cr₂O₃, or pure Co.

These materials are highly active and selective catalyst systems (>95% CH₄ conversion, 97-98% selectivity to CO and H₂). As mentioned above, the low light-off temperatures of these materials (<650° C.) and superior performance make these catalyst systems favorable candidates for further improvement and commercialization. It was observed that the chromium oxide-based catalysts containing cobalt show carbon deposition on the reduced cobalt metal which is formed in situ. The amount of carbon deposition directly correlated with the cobalt metal in the composition. Transmission electron microscopy (TEM) studies indicate that turbostratic carbon is deposited mostly at the cobalt centers, and not on the chromium oxide support or matrix.

### Example 18

### Ni_{0.2}Cr_{0.8}Ox

13.93 ml of Ni(NO₃)₂ of 1.068 M solution (prepared by dissolving Ni(NO₃)₂.6H₂O in water.) Stoichiometry was determined by elemental analysis, ICP) was combined with 119 ml of an aqueous solution of Cr₃(OH)₂(CH₃COO)₇ (0.5M in Cr), prepared by diluting a 2.5603 M solution of chromium hydroxide acetate (prepared by dissolving chromium hydroxide acetate in water). The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation. The Ni_{0.2}Cr_{0.8}Ox powder was evaluated as described above under “Test Procedure,” and the results are shown in Table 4.

### Example 19

### Ni_{0.1}Cr_{0.9}Ox

27.149 ml of an aqueous solution of Cr₃(OH)₂(CH₃COO)₇(1.6575 M in Cr), and 4.682 ml of 1.068 M Ni (NO₃)₂, prepared by dissolving Ni(NO₃)₂.6H₂O in water (stoichiometry determined by elemental analysis (ICP)) were simultaneously added to a 150 ml pyrex petri dish with gentle swirling. The entire solution was rapidly frozen with liquid nitrogen and dried as a frozen solid under vacuum for several days in a Virtis 25EL “Freezemobile” equipped with a Unitop 800 L unit (with refrigerated shelves) to produce a freeze dried powder. The freeze dried material was heated or calcined in air at 350° C. for 5 hrs prior to pelletization and use in a microreactor, as described above under “Test Procedure.” Test results are shown in Table 4.

### Example 20

### Ni_{0.01}Cr_{0.99}Ox

The same procedure was usedas described in Example 19 except that 29.864 ml of the chromium hydroxide acetate solution and 0.468 ml of the nickel nitrate solution were used.

### Example 21

### Y_{0.1}Cr_{0.7}Ni_{0.2}Ox

8.554 ml of 0.9352 M yttrium nitrate solution (prepared by dissolving Y(NO₃)₃ hydrate, Alfa 12898 in water) was combined with 33.786 ml of an aqueous solution of Cr₃(OH)₂(CH₃COO)₇(1.6575 M in Cr), and 14.981 ml of 1.068 M Ni (NO₃)₂ of solution (prepared by dissolving Ni(NO₃)₂.6H₂O in water). The solution was freeze dried, calcined and prepared for testing as described in Example 19.

### Example 22

### La_{0.1}Cr_{0.7}Ni_{0.2}Ox

An identical procedure as described in Example 20 was used to prepare La_{0.1}Cr_{0.7}Ni_{0.2}Ox, except that 6.692 ml of 1.1955 M lanthanum nitrate ((La(NO₃)₃ aqueous solution prepared by dissolving 503.02 g of La(NO₃).xH₂O (Aldrich 23,855-4) in water to make a solution with La content 33.0 wt %,) was combined with 33.786 ml of an aqueous solution of Cr₃(OH)₂(CH₃COO)₇ (1.6575 M in Cr), and 14.981 ml of 1.068 M Ni(NO₃), prepared as described above.

### Example 23

### Ce_{0.1}Cr_{0.7}Ni_{0.2}Ox

An identical procedure as described in Example 20 was used to make Ce_{0.1}Cr_{0.7}Ni_{0.2}Ox, except that 8.00 ml of 1.00 M cerium nitrate (Ce(NO₃)₃ aqueous solution prepared by dissolving 503.02 g of Ce(NO₃). 6H₂O (Alfa 11329) in sufficient water to make a 1 M solution) was combined with 33.786 ml of an aqueous solution of Cr₃(OH)₂(CH₃COO)₇ (1.6575 M in Cr), and 14.981 ml of Ni (NO3)2 of 1.068 M solution (prepared by dissolving Ni(NO₃)₂.6H₂O in water; molarity determined by ICP, elemental analysis).

TABLE 3
Ni—Cr Series Catalysts

| Example No. | Composition |
|---|---|
| 18 | Ni_{0.2} Cro_{0 8} Ox |
| 19 | Ni_{0.1} Cr_{0.9} Ox |
| 20 | Ni_{0.01} Cro_{0.99} Ox |
| 21 | Y_{0.1} Cr_{0.7} Ni_{0.2} Ox |
| 22 | La_{0.1} Cr_{0.7} Ni_{0.2} Ox |
| 23 | Ce_{0.1} Cr_{0.7} Ni_{0.2} Ox |

TABLE 4
Performance of Ni—Cr Series Catalysts

| Ex. | Vol. | | Temp. | | % CH₄ | % O₂ | % CO | % H₂ | | |
|---|---|---|---|---|---|---|---|---|---|---|
| No. | (mL) | Wt. (g) | (° C.) | GHSV × 10⁴ | Conv. | Conv. | Sel. | Sel. | H₂:CO | % Coke |
| 18 | 2.0 | 2.6096 | 686 | 6.1 | 94 | 100 | 97 | 98 | 2.02 | 12.8 |
| | | | 787* | 4.6 | 91 | 100 | 97 | 98 | 2.02 | 12.8 |
| | | | 571* | 7.6 | 93 | 100 | 99 | 99 | 2.00 | 12.8 |
| | | | 599* | 12.2 | 91 | 100 | 98 | 98 | 2.00 | 12.8 |
| | | | 571* | 15.2 | 90 | 100 | 98 | 98 | 2.00 | 23.8** |
| 19 | 2.0 | 2.2551 | 746 | 6.1 | 90 | 100 | 96 | 95 | 1.98 | 0.83 |
| 20 | 2.0 | 2.1817 | 804 | 6.1 | 80 | 100 | 91 | 87 | 1.91 | 0.43 |
| 21 | 2.0 | 2.0049 | 748 | 6.1 | 95 | 100 | 97 | 97 | 2.00 | 2.62 |
| 22 | 2.0 | 2.1250 | 758 | 6.1 | 96 | 100 | 98 | 97 | 1.98 | 1.93 |
| 23 | 2.0 | 2.4859 | 753 | 6.1 | 96 | 100 | 98 | 97 | 1.98 | 1.67 |

Compositions were evaluated for 6 hrs., except where noted otherwise.
*Feed composition 90% CH₄, 30% O₂ and 10% N₂
**Evaluated for 25 hrs.

As illustrated above, by choosing catalyst compounds or catalyst precursor materials which provide higher melting point pure ceramic oxides instead of metals, longer-life catalysts are obtained. By appropriate choice of catalyst composition, as demonstrated herein, sintering phenomena, which typically result in loss of catalytic surface area and eventually activity during use, can be diminished at high temperatures, thereby extending catalyst life. Some compositions which form metal plus ceramic oxide in situ, such as certain Co/Cr and Ni/Cr oxide compositions, may not share this advantage, however. With catalytic use oxides of Co and Ni tend to sinter and to contribute to coking, decreasing catalyst performance and catalyst life. This behavior is more problematic at higher operating temperatures.

In light of the above-described problem, a particularly interesting finding by the inventors was that coke formation is suppressed in the rare earth-containing Ni Cr compounds (e.g., the A_{0.1}Cr_{0.7}Ni_{0.2}Ox series of Examples 21-23), even though the activities demonstrated in these tests appeared to be comparable to that of other Cr-containing compositions, as shown in Table 4. The percent coking with Ni_{0.2}Cr_{0.8}Ox (Example 18), evaluated for 6 hrs, was 12.8%. The same composition evaluated for 25 hrs. experienced 23.8% coke formation. By comparison, the rare earth compounds showed markedly less carbon build-up during a 6 hr evaluation, indicating the desirable longer life of these catalyst compositions. Although not wishing to be limited to any one theory, it is thought that the action of the rare earth oxide may be one of moderating (i.e., lowering) the surface acidity of the oxide, which suppresses some of the acid catalyzed carbon forming reactions.

### Example 24

### Cr_{0.025}(MgO₁₋ₓ(OH)ₓ)_{0.975}(Xerogel)

68.767 ml of 0.3495 M magnesium methoxide solution ((Aldrich 33,565-7), diluted with 50 volume % ethanol (punctilious)), was added to a 150 ml petri dish with gentle swirling under an inert N₂ atmosphere. In a subsequent addition, 1.233 ml of an aqueous solution of Cr₃(OH)₂(CH₃COO)₇(0.5 M in Cr) was introduced to the petri dish while it was gently swirled. Following the addition of the aqueous solutions, a gel point was realized and a homogeneous gel formed which was nearly white in color. The gel was allowed to age 8 days in air and then dried under vacuum at 120° C. prior to use. This catalyst was evaluated as described in the section entitled “Test Procedure,” and the results are shown in Table 6.

### Example 25

### Cr_{0.2}(MgO₁₋ₓ(OH)ₓ)_{0.4}(SiO₂₋ₓ(OH)ₓ)_{0.4}(Xerogel)

57.474 ml of 0.669 M magnesium methoxide solution (Aldrich 33,565-7) and 14.935 ml of tetraethylorthosilicate (TEOS) solution (Aldrich, 13,190-3) diluted with ethanol to 60 volume % TEOS, 40 volume % ethanol), were simultaneously added to a 150 ml petri dish with gentle swirling under a nitrogen atmosphere. In a subsequent step, 7.846 ml of an aqueous solution of Cr₃(OH)₂(CH₃COO)₇(2.5603 M in Cr) was added. A white gel formed, and was allowed to age for 5 days prior to drying in vacuum at 120° C. for 5 hours. This catalyst was evaluated as described in the section entitled “Test Procedure,” and the results are shown in

TABLE 5
Cr Powder Catalysts

| Example No. | Catalyst No. | Composition |
|---|---|---|
| 1 | 92 | Cr_{0.1}La_{0.9}Oₓ |
| 5 | 93 | Cr_{0.1}Sm_{0.9}Oₓ |
| 4 | 94 | Cr_{0.1}Ce_{0.9}Oₓ |
| | 95 | Au_{0.025}Cr_{0.025}Mg_{0.95}Oₓ |
| | 96 | Au_{0.025}Cr_{0.2}Al_{0.775}Oₓ |
| 24 | 97 | Cr_{0.025}Mg_{0.975}Oₓ |
| 25 | 98 | Cr_{0.2}Mg_{0.4}Si_{0.4}Oₓ |
| | 99 | Co_{0.25}Cr_{0.25}Ti_{0.5}Oₓ |
| 11 | 100 | Cr₂O₃ (freeze dry) |
| 12 | 101 | Cr₂O₃ (Aerogel) |
| | 102 | Cr_{0.5}Ti_{0.5} Oₓ (Xerogel) |
| | 103 | Cr_{0.2}Al_{0.4}Si_{0.4}Oₓ |
| | 104 | Co_{0.4}Li_{0.005}TiO₂ |

TABLE 6
Performance of Cr-containing Powder Catalysts

| Catalyst | Vol. | | Temp | | % CH₄ | % O₂ | % CO | % H₂ | |
|---|---|---|---|---|---|---|---|---|---|
| No. | (mL) | Wt. (g) | (° C.) | GHSV × 10⁴ | Conv. | Conv. | Sel. | Sel. | H₂:CO |
| 92 | 2.0 | 2.1417 | 770 | 6.1 | 58 | 100 | 83 | 73 | 1.76 |
| 93 | 0.4 | 0.5350 | 870 | 3.0 | 48 | 100 | 65 | 66 | 2.03 |
| 94 | 0.4 | 0.5972 | 860 | 3.0 | 36 | 100 | 49 | 45 | 1.84 |
| 95 | 2.0 | 0.9560 | 915 | 6.1 | 48 | 100 | 84 | 44 | 1.05 |
| 96 | 0.7 | 0.5685 | 911 | 17.4 | 28 | 92 | 60 | 25 | 0.83 |
| 97 | 2.0 | 0.9024 | 710 | 6.1 | 45 | 100 | 74 | 48 | 1.30 |
| 98 | 2.0 | 1.3851 | 875 | 6.1 | 64 | 100 | 93 | 50 | 1.08 |
| 99 | 2.0 | 1.0605 | 980 | 6.1 | 82 | 100 | 93 | 92 | 1.98 |
| 100 | 2.0 | 2.3529 | 670 | 6.1 | 72 | 100 | 91 | 85 | 1.87 |
| 101 | 0.4 | 0.2180 | 550 | 3.0 | 21 | 99 | 0 | 0 | |
| 102 | 2.0 | 1.2818 | 631 | 6.1 | 0 | 0 | 0 | 0 | |
| 103 | 0.5 | 0.3300 | 845 | 24.4 | 3 | 6 | 23 | 0 | |
| 104 | 2.0 | 2.0573 | 640 | 6.1 | 3 | 2 | 0 | 2 | |

Some non-chromium containing catalyst powders were prepared substantially as described in the foregoing examples. Examples of these compositions are identified in Table 7. Their catalytic performance was evaluated according to the “Test Procedure” described above and the results are reported in Table 8

TABLE 7
Non—Cr Powder Catalysts

| Catalyst No. | Composition |
|---|---|
| 105 | Ru_{0.025} Co_{0.125} Ce_{0.85} Ox |
| 106 | Au_{0.025} Mg_{0.975} Ox |
| 107 | Au_{0.01} La_{0.99} Ox |
| 108 | Co_{0.4}Li_{0.005}TiO₂ |
| 109 | Ru_{0.025}Co_{0.125} Ce_{0.85}Ox |
| 110 | Au_{0.025}Mg_{0.975}Ox |
| 111 | Au_{0.01}Si_{0.99}O₂ |
| 112 | Au_{0.01}La_{0.99}Ox |
| 113 | Au_{0.01}Ce_{0.99}Ox |
| 114 | Au_{0.01}Sn_{0.99}Ox |

TABLE 8
Performance of Non-Cr Powder Catalysts

| Catalyst | Vol. | | Temp | | % CH₄ | % O₂ | % CO | % H₂ | |
|---|---|---|---|---|---|---|---|---|---|
| No. | (mL) | Wt. (g) | (° C.) | GHSV × 10⁴ | Conv. | Conv. | Sel. | Sel. | H₂:CO |
| 105 | 0.4 | 0.2516 | 700 | 3.0 | 0 | 0 | 0 | 0 | |
| 106 | 0.4 | 0.2291 | 870 | 3.0 | 24 | 73 | 60 | 1 | 0.03 |
| 107 | 0.4 | 0.2500 | 850 | 3.0 | 23 | 82 | 33 | 1 | 0.06 |
| 108 | 2.0 | 2.0573 | 640 | 6.1 | 0 | 0 | 0 | 0 | |
| 109 | 2.0 | 3.3520 | 655 | 6.1 | 14 | 45 | 58 | 11 | 0.38 |
| 110 | 1.7 | 0.8465 | 900 | 7.2 | 29 | 82 | 78 | 13 | 0.33 |
| 111 | 1.3 | 0.5255 | 650 | 9.4 | 0 | 0 | 0 | 0 | |
| 112 | 0.2 | 0.2484 | 625 | 61 | 10 | 27 | 54 | 6 | 0.22 |
| 113 | 0.2 | 0.2090 | 650 | 81 | 0 | 0 | 0 | 0 | |
| 114 | 0.1 | 0.0692 | 600 | 122 | 0 | 0 | 0 | 0 | |

As shown in Table 8, these non-chromium containing compositions were not as reactive in the syngas production tests, compared to the Cr-containing catalysts identified above and tested under similar conditions.

Additional cobalt-chromium catalyst powders were prepared as described in the following examples. These compositions are identified in Table 9 and their performance when evaluated according to the “Test Procedure” described above is reported in Table 10.

TABLE 9
Co—Cr Series Catalysts

| Example No. | Catalyst No. | Composition |
|---|---|---|
| 17 | 115 | Co Oxide |
| 14 | 116 | Co_{0.2}Cr_{0.8} Ox |
| 15 | 117 | Co_{0.8}Cr_{0.2} Ox |
| 16 | 118 | Co_{0.5}Cr_{0.5} Ox |
| | 119 | Co_{0.05}Cr_{0.95} Ox |
| | 120 | Co_{0.01}Cr_{0.99} Ox |
| | 121 | Co_{0.1}Cr_{0.9} Ox |
| | 122 | Co_{0.2}Cr_{0 8} Ox |
| 26 | 123 | Co_{0.1}Cr_{0.8}La_{0.1}Ox |

### Example 26

### Co_{0.1}Cr_{0.8}La_{0.l}Ox

6.692 ml of 1.1955 M lanthanum nitrate (La(NO₃)₃ aqueous solution prepared by dissolving 503.02 g of La(NO₃)x H₂O (Aldrich 23,855-4) in sufficient water to make a 33.0 wt % La solution)) was combined with 38.612 ml of an aqueous solution of Cr₃(OH)₂(CH₃COO)₇ (1.6575 M in Cr), and 7.39 ml of 1.0826 M Co(NO₃)₂ solution, (prepared by dissolving Co(NO₃)₂.6H₂O (Alfa 11341) in water). The La, Cr and Co solutions were simultaneously added to a 150 ml pyrex petri dish with gentle swirling. The entire solution was rapidly frozen with liquid nitrogen and dried as a frozen solid under vacuum for several days in a Virtis 25EL “Freezemobile” equipped with a Unitop 800 L unit (with refrigerated shelves) to produce a freeze dried powder. The freeze dried material was heated or calcined in air at 350° C. for 5 hrs prior to pelletization and use in a microreactor. This catalyst (Catalyst No. 123) was evaluated as described in the section entitled “Test Procedure,” and the results are shown in Table 10.

TABLE 10
Performance of Co—Cr Series Catalysts

| Catalyst | Vol. | | Temp | | % CH₄ | % O₂ | % CO | % H₂ | | |
|---|---|---|---|---|---|---|---|---|---|---|
| No. | (mL) | Wt. (g) | (° C.) | GHSV × 10⁴ | Conv. | Conv. | Sel. | Sel. | H₂:CO | % Coke |
| 115 | 0.4 | 0.6826 | 765 | 30.5 | 42 | 100 | 70 | 36 | 1.03 | 0.61 |
| 116 | 2.0 | 2.0793 | 630 | 6.1 | 96 | 100 | 98 | 97 | 1.98 | |
| | 0.4 | 0.5277 | 735 | 22.1 | 93 | 100 | 98 | 98 | 2.00 | |
| | | | 700 | 30.5 | 90 | 100 | 97 | 96 | 1.98 | 2.17 |
| 117 | 2.0 | 2.2806 | 670 | 6.1 | 93 | 100 | 96 | 96 | 2.00 | 21.6 |
| 118 | 2.0 | 1.9917 | 650 | 6.1 | 95 | 100 | 98 | 97 | 1.98 | 5.20 |
| 119 | 2.0 | 2.7451 | 678 | 6.1 | 86 | 100 | 93 | 97 | 2.09 | |
| | | | 786 | 4.4* | 84 | 100 | 91 | 95 | 2.09 | 0.80 |
| 120 | 2.0 | 2.3837 | 727 | 6.1 | 77 | 100 | 88 | 91 | 2.08 | |
| | | | 825 | 4.4* | 77 | 100 | 86 | 90 | 2.09 | 0.42 |
| 121 | 2.0 | 2.9071 | 621 | 6.1 | 92 | 100 | 96 | 97 | 2.02 | |
| | | | 737 | 4.4* | 85 | 100 | 95 | 95 | 2.00 | |
| | | | 571 | 7.5* | 91 | 100 | 99 | 99 | 2.00 | 2.74 |
| 122 | 2.0 | 2.2923 | 655 | 6.1 | 91 | 100 | 97 | 98 | 2.02 | |
| | | | 689 | 4.4* | 93 | 100 | 98 | 99 | 2.02 | |
| 123 | 2.0 | 2.0155 | 660 | 6.1 | 89 | 100 | 96 | 97 | 2.02 | |
| | | | 624 | 7.6* | 91 | 100 | 98 | 98 | 2.00 | |
| | | | 533 | 12.2* | 89 | 100 | 98 | 98 | 2.00 | |
| | | | 492 | 15.2* | 88 | 100 | 98 | 98 | 2.00 | |

*O₂ feed

### Example 27

### La₂O₃ (Comparative Example)

100 ml of a Lanthanum Nitrate solution (1.1955 M, prepared by dissolving 414.13 g of La(NO₃).6H₂O (Alfa 12915) in water) was rapidly frozen in liquid nitrogen. The frozen solution was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### Example 28

### Cr_{0.1}La_{0.9}Ox

95.068 ml of a Lanthanum Nitrate solution (1.1955 M, prepared by dissolving 414.13 g of La(NO₃).6H₂O (Alfa 12915) in sufficient water to make a 1.1955 M solution) was simultaneously added to 4.3932 ml of an aqueous solution of chromium hydroxide acetate solution (2.5603 M in Cr, as determined by ICP analysis). The solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° /min to 350° C., 350° C. for 5 hours, 5° C./min to 525° C., 525° C. 1 hour; 10° C./min to room temperature. The material was pelletized and sieved prior to the reactor evaluation as described above.

### Example 29

### Cr_{0.25}La_{0.75}Ox

86.532ml of a 1.1955 M aqueous lanthanum nitrate solution , prepared as described in the foregoing Example, was added to a 13.468 ml of an aqueous solution of chromium hydroxide acetate (2.5603 M in Cr). The solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### Example 30

### Cr_{0.5}La_{0.5}Ox

68.169 ml of the previously described 1.1955 M lanthanum nitrate solution was added to 31.831 ml of an aqueous solution of chromium hydroxide acetate (2.5603 M in Cr). The solution was rapidly frozen in liquid nitrogen, placed in a freeze dryer (Virtis Corporation, shelves refrigerated to 0° C.), and evacuated to dryness over a period of 5-7 days, or until completely dry. The freeze-dried material was then calcined in air according to the following schedule: 5° C./min to 350° C., 350° C. for 5 hours, 5° C./min to 525° C., 525° C. 1 hour; 10° C./min to room temperature. The material was pelletized and sieved prior to the reactor evaluation as described above.

### Example 31

### Cr_{0.75}La_{0.25}Ox

41.653 ml of an aqueous lanthanum nitrate solution (1.1955 M) was added to 58.347 ml of aqueous chromium hydroxide acetate solution (2.5603 M in Cr). The solution was rapidly frozen in liquid nitrogen, freeze-dried, and calcined as described in the foregoing example. The calcined material was then pelletized and sieved prior to the reactor evaluation as described above.

### Example 32

### Cr_{0.9}La_{0.1}Ox

19.222 ml of aqueous lanthanum nitrate solution (1.1955 M) was added to 80.778 ml of an aqueous solution of chromium hydroxide acetate(2.5603 M in Cr)). The solution was rapidly frozen in liquid nitrogen, freeze-dried, calcined, pelletized and sieved, as described in the foregoing example, after which it was tested in the reduced-scale reactor as described under “Test Procedure.”

TABLE 11
La—Cr Ox Series Catalysts

| Example No. | Composition |
|---|---|
| 27 | La₂O₃ |
| 28 | Cr_{0.1}La_{0.9} Ox |
| 29 | Cr_{0.25}La_{0.75} Ox |
| 30 | Cr_{0.5}La_{0.5} Ox |
| 31 | Cr_{0.75}La_{0.25} Ox |
| 32 | Cr_{0.9}La_{0.1} Ox |

TABLE 12
Performance of La—CrOx Series Catalysts

| Example | Vol. | | Temp | | % CH₄ | % O₂ | % CO | % H₂ | |
|---|---|---|---|---|---|---|---|---|---|
| No. | (mL) | Wt. (g) | (° C.) | GHSV × 10⁴ | Conv. | Conv. | Sel. | Sel. | H₂:CO |
| 27 | 2.0 | 2.3996 | 860 | 6.1 | 55 | 100 | 70 | 55 | 1.57 |
| 28 | 2.0 | 2.2106 | 830 | 6.1 | 43 | 100 | 63 | 46 | 1.46 |
| 29 | 2.0 | 1.5846 | 955 | 6.1 | 51 | 100 | 67 | 52 | 1.55 |
| 30 | 2.0 | 2.2184 | 746 | 6.1 | 59 | 100 | 85 | 72 | 1.69 |
| 31 | 2.0 | 1.9359 | 834 | 6.1 | 69 | 100 | 87 | 78 | 1.79 |
| 32 | 2.0 | 1.9517 | 873 | 6.1 | 69 | 100 | 90 | 80 | 1.78 |

### Example 33

### Zn_{0.2}Cr_{0.8}Ox

14.88 ml of Zn (NO₃)₂ of 1.0 M solution was combined with 119 ml of an aqueous solution of Cr₃(OH)₂(CH₃COO)₇ (0.5 M in Cr) prepared by diluting an aqueous 2.5603 M chromium hydroxide acetate (Aldrich 31,810-8) solution with sufficient water to make a solution that is 0.5M in chromium. The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 34

### Cu_{0.2}Cr_{0.8}Ox

14.88 ml of Cu (NO₃)₂.3H₂O, 1.0 M aqueous solution was combined with 119 ml of an aqueous solution of Cr₃(OH)₂(CH₃COO)₇(0.5M in Cr), prepared as described in Example 39. The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 35

### Fe_{0.2}Cr_{0.8}Ox

14.88 ml of Fe(NO₃)₃.6H₂O, 1.0 M aqueous solution was combined with 119 ml of an aqueous solution of Cr₃(OH)₂ (CH₃COO)₇ (0.5M in Cr), prepared as described above. The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 36

### V_{0.2}Cr0.8Ox

194.66 ml of ammonium metavandate (NH₄VO₃, solution concentration determined by elemental, ICP analysis to be 0.07644 M in V) was combined with 119 ml of an aqueous solution of Cr₃(OH)₂(CH₃COO)₇(0.5M in Cr), prepared as previously described. The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., to room temper 525° C. soak for 1 hour; 10° C./min to room temperature. The material was sieved prior to the reactor evaluation.

### Example 37

### Mn_{0.2}Cr_{0.8}Ox

6.103 g of Mn(NO₃)₂(Alfa, 87848, Mn(NO₃)₂.xH₂O, contains 22.56 wt % as Mn) was added to 200 ml of an aqueous solution of Cr₃(OH)₂(CH₃COO)₇(0.5M in Cr), prepared as previously described. The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 38

### Co_{0.2}W_{0.8}Ox

6.0 ml Co(NO₃)₂.6H₂O (Alfa, 11341) aqueous solution of 1.0 M solution was simultaneously combined with 109.639 ml of an aqueous solution of (NH₄)₁₀W₁₂O₄₁.5H₂(Alfa, 10899) (0.2189 M in W). The mixed solution was rapidly frozen in liquid nitrogen. It was placed in a freeze dryer (Virtis Corporation, shelves refrigerated to 0 C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 39

### Ni_{0.2}W_{0.8}Ox

4.682 ml Ni(NO₃)₂ aqueous solution of 1.068 M solution (determined by ICP analysis)was simultaneously combined with 91.366 ml of (NH₄)₁₀W₁₂O₄₁.5H₂O (Alfa, 10899) (0.2189M in W). The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 40

### Cu_{0.2}W_{0.8}Ox

1.5177 ml of 3.9535 M Cu(NO₃)_{2.5}H₂O (Aldrich, 2239-5) aqueous solution was simultaneously combined with 109.639 ml of an aqueous solution of (NH₄)₁₀W₁₂O₄₁.5H₂O (Alfa, 10899) (0.2189 M in W). The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 41

### Ni_{0.2}Mo_{0.8}Ox

9.363 ml Ni(NO₃)₂ aqueous solution of 1.068 M solution (determined by ICP analysis) was simultaneously combined with 80.0 ml of an aqueous solution of (NH₄)₆Mo₇O₄₀.4H₂O (Alfa, 11831) (0.5M in Mo). The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 42

### Co_{0.2}Mo_{0.8}Ox

10.0 ml Co(NO₃)₂.6H₂O (Alfa, 11341) aqueous solution of 1.068 M solution (determined by ICP analysis) was simultaneously combined with 80.0 ml of an aqueous solution of (NH₄)₆Mo₇O₄₀4H₂O (Alfa, 11831) (0.5M in Mo). The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

### Example 43

### Cu_{0.2}Mo_{0.8}Ox

2.5295 ml of an aqueous 3.9535 M Cu (NO₃)₂.5H₂O (Aldrich, 2239-5) was simultaneously combined with 80.0 ml of an aqueous solution of (NH₄)₆Mo₇O₄₀.4H₂O (Alfa, 11831) (0.5M in Mo). The mixed solution was rapidly frozen in liquid nitrogen. It was placed in a freeze dryer (Virtis Corporation, shelves refrigerated to 0° C.) and evacuated to dryness over a period of 5-7 days, or until completely dry. The material was calcined in air according to the following schedule: 5° C./min to 350° C., 5 hour soak at 350° C., 5° C./min to 525° C., 525° C. soak for 1 hour; 10° C./min to room temperature. The material was sieved prior to the reactor evaluation.

TABLE 13
M_{0.2}Cr_{0.8} Ox Series Catalysts

| Example No. | Composition |
|---|---|
| 33 | Zn_{0.2} Cr_{0.8} Ox |
| 34 | Cu_{0.2} Cr_{0.8} Ox |
| 35 | Fe_{0.2} Cr_{0.8} Ox |
| 36 | V_{0.2} Cr_{0.8} Ox |
| 37 | Mn_{0.2} Cr_{0.8} Ox |
| 38 | Co_{0.2} W_{0.8} Ox |
| 39 | Ni_{0.2} W_{0 8} Ox |
| 40 | Cu_{0.2} W_{0.8} Ox |
| 41 | Ni_{0.2} Mo_{0.8} Ox |
| 42 | Co_{0.2} Mo_{0.8} Ox |
| 43 | Cu_{0.2} Mo_{0.8} Ox |

TABLE 14
Performance of M_{0.2}Cr_{0.8}Ox Series Catalysts

| Catalyst | Vol. | | Temp | | % CH₄ | % O₂ | % CO | % H₂ | | |
|---|---|---|---|---|---|---|---|---|---|---|
| No. | (mL) | Wt. (g) | (° C.) | GHSV × 10⁴ | Conv. | Conv. | Sel. | Sel. | H₂:CO | % Coke |
| 33 | 2.0 | 2.4031 | 696 | 6.1 | 73 | 100 | 89 | 85 | 1.91 | 0.21 |
| 34 | 2.0 | 2.4873 | 748 | 6.1 | 62 | 100 | 82 | 74 | 1.81 | 17.4 |
| 35 | 2.0 | 2.6567 | 778 | 6.1 | 69 | 100 | 88 | 84 | 1.91 | 0.25 |
| 36 | 2.0 | 2.0431 | 703 | 6.1 | 59 | 100 | 83 | 74 | 1.78 | 0.30 |
| 37 | 2.0 | 2.4971 | 777 | 6.1 | 66 | 100 | 87 | 82 | 1.89 | 0.21 |

| | | | | | |
|---|---|---|---|---|---|
| 38 | 2.0 | 3.4235 | 604 | 6.1 | little conversion |
| 39 | 2.0 | 3.6498 | 650 | 6.1 | little conversion |
| 40 | 2.0 | 3.4032 | 623 | 6.1 | no conversion |
| 41 | 2.0 | 2.5265 | 652 | 6.1 | little conversion |
| 42 | 2.0 | 2.3329 | 643 | 6.1 | no light-off |
| 43 | 2.0 | 2.4575 | 670 | 6.1 | no light-off |

In the series of compositions shown in Table 14, it can be seen that the non-Cr containing systems (Examples 39-43) showed no light off when tested as described in the section entitled “Test Procedure.”

Process of Producing Syngas

Any suitable reaction regime is applied in order to contact the reactants with the catalyst. One suitable regime is a fixed bed reaction regime, in which the catalyst is retained within a reaction zone in a fixed arrangement. Supported or self-supporting catalysts may be employed in the fixed bed regime, retained using fixed bed reaction techniques well known in the art. Preferably a millisecond contact time reactor is employed. Several schemes for carrying out catalytic partial oxidation (CPOX) of hydrocarbons in a short contact time reactor have been described in the literature. For example, L. D. Schmidt and his colleagues at the University of Minnesota describe a millisecond contact time reactor in U.S. Pat. No. 5,648,582 and in J. Catalysis 138, 267-282 (1992) for use in the production of synthesis gas by direct oxidation of methane over a catalyst such as platinum or rhodium. A general description of major considerations involved in operating a reactor using millisecond contact times is given in U.S. Pat. No. 5,654,491. The disclosures of the above-mentioned references are incorporated herein by reference.

Accordingly, a feed stream comprising a hydrocarbon feedstock and an oxygen-containing gas is contacted with one of the above-described chromium-based catalysts in a reaction zone maintained at conversion-promoting conditions effective to produce an effluent stream comprising carbon monoxide and hydrogen. The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane.

The hydrocarbon feedstock is contacted with the catalyst as a gaseous phase mixture with an oxygen-containing gas, preferably pure oxygen. The oxygen-containing gas may also comprise steam and/or CO₂ in addition to oxygen. Alternatively, the hydrocarbon feedstock is contacted with the catalyst as a mixture with a gas comprising steam and/or CO₂. Preferably, the methane-containing feed and the oxygen-containing gas are mixed in such amounts to give a carbon (i.e., carbon in methane) to oxygen (i.e., oxygen) ratio from about 1.25:1 to about 3.3:1, more preferably, from about 1.3:1 to about 2.2:1, and most preferably from about 1.5:1 to about 2.2:1, especially the stoichiometric ratio of 2:1.

The process is operated at atmospheric or superatmospheric pressures, the latter being preferred. The pressures may be from about 100 kPa to about 12,500 kPa, preferably from about 130 kPa to about 10,000 kPa. The process of the present invention may be operated at temperatures of from about 600° C. to about 1,100° C., preferably from about 700° C. to about 1,000° C. The hydrocarbon feedstock and the oxygen-containing gas are preferably pre-heated before contact with the catalyst. The hydrocarbon feedstock and the oxygen-containing gas are passed over the catalyst at any of a variety of space velocities.

Gas hourly space velocities (GHSV) for the process, stated as normal liters of gas per kilogram of catalyst per hour, are from about 20,000 to at least about 100,000,000 NL/kg/h, preferably from about 50,000 to about 50,000,000 NL/kg/h. Preferably the catalyst is employed in a millisecond contact time reactor for syngas production. The process preferably includes maintaining a catalyst residence time of no more than 10 milliseconds for the reactant gas mixture. Residence time is the inverse of the space velocity, and high space velocity equates to low residence time on the catalyst. The effluent stream of product gases, including CO and H2, emerges from the reactor. Although not wishing to be bound by any particular theory, the inventors believe that the primary reaction catalyzed by the preferred catalysts described herein is the partial oxidation reaction of Equation 2, described above in the background of the invention. Additionally, other chemical reactions may also occur to a lesser extent, catalyzed by the same catalyst composition. For example, in the course of syngas generation, intermediates such as CO₂+H₂O may occur as a result of the oxidation of methane, followed by a reforming step to produce CO and H₂. Also, particularly in the presence of carbon dioxide-containing feedstock or CO₂ intermediate, the reaction CH₄+CO₂→2CO+2H₂(3) may also occur during the production of syngas.

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of U.S. Provisional Application Nos. 60/183,423 and 60/183,575, and the disclosures of all patents and publications cited herein are incorporated by reference.

What is claimed is:

1. A chromium-based composition active for catalyzing the conversion of a C₁-C₅ hydrocarbon under catalytic partial oxidation promoting conditions in the presence of O₂ to a product gas mixture comprising CO and H₂, the composition comprising:
about 0.1-100 mole % of chromium or chromium-containing compound per total moles of metal or metal ion in said composition; and
at least one other elemental metal or metal-containing compound, the metal of which is chosen from the group consisting of Li, Na, K, Rb, Cs, Mg, Ca, Sr, Ba, Cu, Ag, Au, Zn, Cd, La, Ce, Pr, Nd, Sm, Eu, Gd, Tb, Dy, Ho, Er, Tm, Yb, Lu, Co, Ni, Ru and Rh, said composition comprising a structure other than a perovskite structure.

2. The composition of claim 1 wherein said chromium or chromium-containing compound comprises about 10-100 mole % of the total moles of metal or metal ion in said composition.

3. The composition of claim 1 wherein said composition initially comprises a catalyst precursor comprising a metal/metal oxide, and after operation in a short contact time syngas reactor for the production of syngas, finally comprises a reduced metal and a metal oxide.

4. The composition of claim 3 wherein said catalyst precursor comprises CoCr₂O₄ and said reduced metal is zero valent cobalt metal and said metal oxide is Cr₂O₃.

5. The composition of claim 4 wherein said composition finally comprises reduced metal and/or metal oxide and substantially no deposited carbon after reaction in a syngas reactor for at least 6 hrs.

6. The composition of claim 1 wherein said composition comprises a matrix structure chosen from the group consisting of xerogels and aerogels.

7. The composition of claim 6 wherein said matrix structure comprises said at least one oxide or oxyhydroxide of a metal chosen from the group consisting of magnesium, silicon, titanium, tantalum, zirconium and aluminum.

8. The composition of claim 1 wherein said matrix structure comprises at least 30 wt % of the total weight of said composition.

9. The composition of claim 1 wherein said matrix structure comprises about 30-99.9 mole % of the total moles (of metal) of said composition.

10. The composition of claim 1 wherein said matrix structure comprises about 50-97.5 mole % of the total moles (of metal) of said composition.

11. The composition of claim 1 wherein said matrix structure comprises titanium oxide/oxyhydroxide.

12. The composition of claim 1 wherein said matrix structure comprises magnesium oxide/oxyhydroxide and silicon oxide/oxyhydroxide.

13. The composition of claim 1 wherein the metal or metal ion of said at least one other elemental metal or metal-containing compound is cobalt.

14. The composition of claim 1 wherein the metal or metal ion of said at least one other elemental metal or metal-containing compound is lanthanum.

15. The composition of claim 1 wherein the metal or metal-containing compound of said at least one other elemental metal or metal-containing compound is magnesium and silicon oxide/oxyhydroxide.

16. The composition of claim 1 wherein the metal or metal-containing compound of said at least one other elemental metal or metal-containing compound is cerium.

17. The composition of claim 1 wherein the metal or metal-containing compound of said at least one other elemental metal or metal-containing compound is samarium.

18. The composition of claim 1 wherein the metal or metal-containing compound of said at least one other elemental metal or metal-containing compound is gold and aluminum oxide/oxyhydroxide.

19. The composition of claim 1 wherein the metal or metal-containing compound of said at least one other elemental metal or metal-containing compound is gold, and magnesium oxide/oxyhydroxide.

20. The composition of claim 1 wherein the metal or metal-containing compound of said at least one other elemental metal or metal-containing compound is chosen from the group consisting of lanthanum, lithium and α-Al₂O₃.

21. A supported syngas catalyst comprising the composition of claim 1 disposed on an oxidatively and thermally stable porous support.

22. The supported syngas catalyst of claim 21 wherein said porous support comprises at least one oxide or oxyhydroxide of a metal chosen from the group consisting of magnesium, silicon, titanium, tantalum, zirconium and aluminum.

23. The composition of claim 22 wherein said support is a porous three-dimensional monolith.

24. The composition of claim 23 wherein said support is a reticulated ceramic or ceramic foam.

25. The composition of claim 1 comprising nickel and/or nickel oxide in an atomic ratio of 0.01-0.2; and chromium and/or chromium oxide in an atomic ratio of 0.8-0.99.

26. The composition of claim 1 comprising the general formula: A_{0.1}Cr_{0.7}Ni_{0.2}, wherein A is a rare earth element chosen from the group consisting of Y, La and Ce.

27. The composition of claim 1 comprising the general formula: Aₓ Cr_{y} Oxide wherein
A is a rare earth element chosen from the group consisting of La, Sm and Ce;
x is an atomic ratio of 0.9-0.1;
y is an atomic ratio of 0.1-0.9; and
x+y=1.

28. The composition of claim 1 comprising the general formula: A_{0.2}Cr_{0.8}Co_{0.1} Oxide wherein A is a rare earth element.

29. The composition of claim 1 comprising the general formula: A_{0.2}Cr_{0.8} Oxide wherein A is a transition metal chosen from the group consisting of V, Cr, Mn, Fe, Co, Ni, Cu and Zn.

30. A process for preparing a chromium-based composition active for catalyzing the conversion of a C₁-C₅ hydrocarbon in the presence of O₂ to a product gas mixture comprising CO and H₂, the process comprising combining
about 0.1-100 mole % elemental chromium or chromium-containing compound per total moles of metal in said composition,
optionally, at least one other metal or metal oxide the metal component of which is chosen from the group consisting of Li, Na, K, Rb, Cs, Mg, Ca, Sr, Ba, Cu, Ag, Au, Zn, Cd, La, Ce, Pr, Nd, Sm, Eu, Gd, Tb, Dy, Ho, Er, Tm, Yb, Lu, Co, Ni, Ru and Rh, and
optionally, at least one matrix-forming material chosen from the group consisting of the alkoxides of magnesium, silicon, titanium, tantalum, zirconium and aluminum; and
forming said combination into a porous solid.

31. The process of claim 30 wherein said combining step includes combining a matrix-forming material comprising at least 30 wt % of the total weight of said composition with said chromium compound and said at least one other metal compound.

32. The process of claim 30 wherein said matrix-forming material comprises titanium or titanium oxide.

33. The process of claim 30 wherein said matrix-forming material comprises a combination of oxides or alkoxides of magnesium and silicon.

34. The process of claim 30 further comprising:
preparing an intermediate composition comprising said chromium or chromium-containing compound and said at least one other metal or metal-containing compound; and
applying said intermediate composition to a porous matrix material comprising at least 30 wt % of the total weight of said composition.

35. The process of claim 34 wherein said step of applying comprises applying said intermediate composition to a porous monolith support.

36. The process of claim 35 wherein said intermediate composition is in the form of a liquid and said step of applying said intermediate composition to said porous matrix material comprises impregnating said porous matrix with said liquid.

37. The process of claim 30 wherein said forming comprises drying said composition.

38. The process of claim 37 further comprising thermally treating said composition.

39. The process of claim 38 wherein said step of thermally treating comprises thermally treating said composition in situ under reaction conditions.

40. The process of claim 37 wherein said step of forming comprises freeze-drying said intermediate composition.

41. The process of claim 37 wherein said step of forming comprises spray drying said intermediate composition.

42. The process of claim 37 wherein said step of forming comprises spray roasting said intermediate composition.

43. The process of claim 30 wherein said step of forming comprises forming a powder.

44. The process of claim 43 wherein said step of forming further comprises forming a pellet.

45. The process of claim 30 wherein said step of forming comprises forming an extrudate.

46. The process of claim 30 wherein said step of forming comprises forming a gel chosen from the group consisting of xerogels and aerogels.

47. The process of claim 30 wherein said matrix-forming material comprises at least one metal alkoxide.

48. The process of claim 47 wherein each said at least one metal alkoxide is chosen from the group consisting of metal alkoxides containing 1 to 20 carbon atoms.

49. The process of claim 48 wherein each said at least one metal alkoxide is chosen from the group consisting of metal alkoxides containing 1 to 5 carbon atoms.

50. The process of claim 49 wherein each said at least one metal alkoxide is a C₁-C₄ alkoxide chosen from the group consisting of tantalum n-butoxide, titanium isopropoxide and zirconium isopropoxide.

51. The process of claim 50 further comprising dissolving at least one said metal alkoxide in a non-aqueous medium to form an metal alkoxide solution.

52. The process of claim 51 further comprising mixing said metal alkoxide solution with a protic solvent whereby said at least one alkoxide reacts with said protic solvent to form a gel.

53. The process of claim 52 further comprising dissolving said chromium or chromium-containing compound in said protic solvent to form a protic catalytic metal solution.

54. The process of claim 53 wherein said protic solvent is water.

55. The process of claim 47 further comprising dissolving or suspending said matrix material in said non-aqueous liquid medium to form a non-aqueous matrix solution or colloidal suspension.

56. The process of claim 47 further comprising dissolving said at least one other elemental metal or metal-containing compound and said at least one matrix-forming component in a non-aqueous medium.

57. The process of claim 52 wherein said mixing comprises combining said protic solvent and said alkoxide in a molar ratio of about 5:1 to 53.1.

58. The process of claim 57 wherein said mixing comprises combining said protic solvent and said alkoxide in a molar ratio of at least about 26.5:1.

59. The process of claim 52 wherein said mixing comprises the gradual addition of sufficient protic solution to induce hydrolysis and condensation of said at least one metal alkoxide.

60. The process of claim 59 wherein said mixing comprises combining said water and said alkoxide in a molar ratio of about 0.1:1 to 10:1 water:alkoxide.

61. The process of claim 60 wherein said alkoxide is chosen from the group consisting of alkoxides of zirconium and titanium, and said mixing comprises combining said water and said alkoxide in a molar ratio of about 4:1.

62. A process for converting a C₁-C₅ hydrocarbon in the presence of O₂ to a product gas mixture containing CO and H₂, the process comprising
mixing a C₁-C₅ hydrocarbon-containing feedstock and an O₂-containing feedstock to provide a reactant gas mixture;
in the reaction zone of a short contact time reactor, contacting said reactant gas mixture with a catalytically effective amount of the catalyst composition of claim 1;
during said contacting, maintaining catalytic partial oxidation reaction promoting conditions of temperature, pressure, space velocity and feed composition.

63. The process of claim 62 wherein said step of maintaining catalytic partial oxidation reaction promoting conditions comprises maintaining said reaction zone at a temperature of about 600-1,100° C.

64. The process of claim 63 wherein said step of maintaining catalytic partial oxidation reaction promoting conditions comprises maintaining said reaction zone at a temperature of about 700-1,000° C.

65. The process of claim 62 wherein said step of maintaining catalytic partial oxidation reaction promoting conditions comprises maintaining said reactant gas mixture at a pressure of about 100-12,500 kPa.

66. The process of claim 65 wherein said step of maintaining catalytic partial oxidation reaction promoting conditions comprises maintaining said reactant gas mixture at a pressure of about 130-10,000 kPa.

67. The process of claim 62 wherein said step of maintaining catalytic partial oxidation reaction promoting conditions comprises passing said reactant gas mixture over said composition at a continuous space velocity of about 20,000 to at least about 100,000,000 NL/kg/h.

68. The process of claim 67 wherein said step of passing said reactant gas mixture over said composition comprises passing said mixture at a space velocity of about 50,000 to about 50,000,000 NL/kg/h.

69. The process of claim 62 wherein said step of maintaining catalytic partial oxidation reaction promoting conditions comprises ensuring a reactant gas mixture/catalyst composition contact time of no more than about 10 milliseconds.

70. The process of claim 62 wherein said step of maintaining catalytic partial oxidation reaction promoting conditions further comprising mixing a methane-containing gas feedstock and an oxygen-containing gas feedstock to provide a reactant gas mixture having a carbon:oxygen ratio of about 1.25:1 to about 3.3:1.

71. The process of claim 70 wherein said mixing provides a reactant gas mixture having a carbon:oxygen ratio of about 1.3:1 to about 2.2:1.

72. The process of claim 71 wherein said mixing provides a reactant gas mixture having a carbon:oxygen ratio of about 1.5:1 to about 2.2:1.

73. The process of claim 72 wherein said mixing provides a reactant gas mixture having a carbon:oxygen ratio of about 2:1.

74. The process of claim 62 wherein said O₂-containing gas further comprises steam and/or CO₂.

75. The process of claim 62 further comprising mixing a hydrocarbon feedstock with an O₂-containing gas comprising steam and/or CO₂ to provide said reactant gas mixture.

76. The process of claim 62 wherein said C₁-C₅ hydrocarbon comprises at least about 50% methane by volume.

77. The process of claim 76 wherein said C₁-C₅ hydrocarbon comprises at least about 75% methane by volume.

78. The process of claim 77 wherein said C₁-C₅ hydrocarbon comprises at least about 80% methane by volume.

79. The process of claim 62 further comprising preheating at least one of said hydrocarbon feedstock and said O₂-containing feedstock before contacting said catalyst.

80. The process of claim 62 further comprising retaining said composition in a fixed bed reaction zone.

81. The process of claim 62 wherein said composition is nominally 0.8 mole % in elemental chromium or chromium ion and 0.2 mole % in elemental cobalt or cobalt ion.

82. The process of claim 62 wherein said composition is nominally 0.2 mole % in elemental chromium or chromium ion and 0.8 mole % in elemental cobalt or cobalt ion.

83. The process of claim 62 wherein said composition is nominally 0.5 mole % in elemental chromium or chromium ion and 0.5 mole % in elemental cobalt or cobalt ion.

84. The process of claim 82 wherein said composition is nominally 2-10 mole % chromium or chromium ion, 1 mole % in lithium or lithium ion and 27 mole % lanthanum or lanthanum ion and comprises an α-AλO₃συππoρτ.

85. A process for converting a C₁-C₅ hydrocarbon in the presence of O₂ to a product gas mixture containing CO and H₂, the process comprising:
mixing a C₁-C₅ hydrocarbon-containing feedstock and an oxygen-containing feedstock to provide a reactant gas mixture;
in a short contact time reactor, contacting said reactant gas mixture with a catalytically effective amount of a catalyst precursor comprising CoCr₂O₄ cubic spinel dispersed in a chromium oxide matrix;
during said contacting, maintaining said composition and said reactant gas mixture at a temperature of about 600-1,100° C.;
during said contacting, maintaining said composition and said reactant gas mixture at a pressure of about 100-12,500 kPa;
passing said reactant gas mixture over said composition at a continuous flow rate of about 20,000 to at least about 100,000,000 NL/kg/h,
such that at least a portion of said catalyst precursor is reduced to cobalt metal dispersed in a chromium oxide matrix during said contacting.

86. A process for converting a C₁-C₅ hydrocarbon comprising at least about 80 vol % methane to a product gas mixture comprising CO and H₂, the process comprising:
mixing a methane-containing gaseous feedstock and an O₂-containing gaseous feedstock to provide a reactant gas mixture having a carbon:oxygen ratio of about 1.25:1 to about 3.3:1;
preheating at least one of said gaseous feedstocks to a temperature up to about 700° C.; contacting said reactant gas mixture with a catalytically effective amount of a chromium-based composition containing
10-100 mole % (as the metal) of chromium or chromium-containing compound per total moles of metal or metal ion in said composition,
0-90% cobalt or cobalt-containing compound, said composition comprising a structure other than a perovskite structure, and
optionally, an oxidatively and thermally stable porous support supporting said chromium or chromium-containing compound and said cobalt or cobalt-containing compound;
during said contacting, maintaining said composition and said reactant gas mixture at a temperature of about 600-1,100° C.;
during said contacting, maintaining said composition and said reactant gas mixture at a pressure of about 100-12,500 kPa; and
passing said reactant gas mixture over said composition at a continuous flow rate of about 20,000 to 100,000,000 NL/kg/h, such that the contact time of said reactant gas mixture/catalyst composition is no more than about 10 milliseconds.
